(19) United States
(12) Patent Application Publication
(10) Pub. No.: US 2026/0194923 A1
(43) Pub. Date: Jul. 9, 2026

(54) ADAPTIVE ROBOT CONTROLLER FOR LOW-ENERGY BEHAVIOR THAT MAINTAINS THERMAL CONSTRAINTS

(71) Applicant: Fauna Robotics Inc, New York, NY (US)

(72) Inventors: Diego Etiony Aldarondo, Croton-on-Hudson, NY (US); Emma Reznick, Brooklyn, NY (US); David William Petrillo, Brooklyn, NY (US); Joshua Scott Merel, New York, NY (US)

(73) Assignee: Fauna Robotics Inc, New York, NY (US)

(21) Appl. No.: 19/554,900

(22) Filed: Mar. 3, 2026

Related U.S. Application Data
(63) Continuation-in-part of application No. 19/410,966, filed on Dec. 5, 2025.
(60) Provisional application No. 63/736,930, filed on Dec. 20, 2024.
(60) Provisional application No. 63/735,617, filed on Jan. 6, 2025.
(60) Provisional application No. 63/766,043, filed on Mar. 3, 2025.
(60) Provisional application No. 63/932,552, filed on Dec. 5, 2025.

(51) Int. Cl. G05D 1/83; B25J 9/00; G05D 1/633; G05D 1/85; G05D 1/86; G05D 101/15; G06V 10/764

(52) U.S. Cl. CPC G05D 1/83; B25J 9/0003; G05D 1/633; G05D 1/852; G05D 1/86; G06V 10/764; G05D 2101/15; G06V 2201/06

(57) ABSTRACT

Aspects of the present disclosure relate to systems and methods for enforcing safe operational limits on the control signals used to operate a robotic system in a human-centric environment to protect against damage to the robotic components. According to an aspect of the present disclosure, the robotic system generates an intervention signal when control signals exceed safe operating limits. The intervention signal may be used to signal a warning to a user and/or may cause the system to change poses or activities to restore the robotic system to operating within the safe operating limits. Some aspects of the present disclosure relate to monitoring the power usage and/or temperature of components of the robotic system. One or more aspects of the present disclosure may be used in combination with each other and/or may be used with additional systems and processes for controlling a robotic system in a human-centric environment.

### CROSS-REFERENCE TO RELATED APPLICATIONS

This application is a continuation-in-part claiming the benefit of priority under 35 U.S.C. § 120 of U.S. patent application Ser. No. “19/410,966”, filed on Dec. 5, 2025, and entitled “METHOD FOR SPATIAL MAPPING AND EVENT DETECTION IN DYNAMIC ENVIRONMENTS”, which claims the benefit of priority under 35 U.S.C. § 119 (e) to U.S. Provisional Patent Application Ser. “63/736,930”, filed on Dec. 20, 2024, and entitled “METHOD FOR SEQUENTIAL TASK MANAGEMENT AND VISUOMOTOR POLICY INTEGRATION IN DYNAMIC ENVIRONMENTS,” and to U.S. Provisional Patent Application Ser. No. “63/735,617”, filed on Jan. 6, 2025, and entitled “METHOD FOR SPATIAL MAPPING AND EVENT DETECTION IN DYNAMIC ENVIRONMENTS,” each of which applications is incorporated by reference herein in their entirety. This application also claims the benefit of priority under 35 U.S.C. § 119 (e) to U.S. Provisional Patent Application Ser. No. “63/766,043”, filed on Mar. 3, 2025, and entitled “ADAPTIVE ROBOT CONTROLLER FOR LOW-ENERGY BEHAVIOR THAT MAINTAINS THERMAL CONSTRAINTS,” and to U.S. Provisional Patent Application Ser. No. “63/932,552”, filed on Dec. 5, 2025, and entitled “SYSTEM AND METHODS FOR SAFE LOCOMOTION AND FAILURE HANDLING FOR A ROBOTIC SYSTEM” each of which applications are hereby incorporated by reference herein in their entirety.

### BACKGROUND

Robotic systems use hardware and corresponding software components to control the hardware to provide autonomous, semi-autonomous, or remote control of the robotic system. Robotic systems can be assembled in various form factors depending on the configuration of the robotic hardware. Conventional robotic systems are used in industrial automation and rely on predefined loops to control the robotic system and/or simple decision binaries for providing automated industrial processes. Industrial automation has centered around efficiency of assembly relative to corresponding human workers.

### SUMMARY

It is appreciated that industrial automation with robotic systems largely operates in environments without humans in proximity or with defined safe areas where the robotic system does not pose a risk to human operators that may be in the vicinity. In some embodiments, robotic systems are provided that include capabilities and logic that are sensitive to the presence of humans (e.g., in a human-centric environment) to perform work safely within those environments.

Some embodiments provide for a robotic system comprising: a plurality of mechanical joints configured between components of the robotic system such that the components are movably connected; a plurality of actuators configured to control positions of the plurality of mechanical joints; a plurality of sensors configured to detect operating conditions of respective actuators of the plurality of actuators; a processor configured to control power to the plurality of actuators and to process signals received from the plurality of sensors; and a non-transitory computer-readable storage medium storing processor executable instructions that when executed by the at least one computer hardware processor enforce safe operating limits of the robotic system, wherein the processor executable instructions cause the processor to: receive sensor data from the plurality of sensors; generate control signals for controlling the plurality of actuators; determine whether the control signals exceed safe operating limits; and upon determining the control signals exceed the safe operating limits, generate an intervention signal.

Some embodiments provide for a method for enforcing safe operating limits of a robotic system, the method comprising: receiving sensor data from the plurality of sensors; generating control signals for controlling the plurality of actuators; determining whether the control signals exceed safe operating limits; and upon determining the control signals exceed the safe operating limits, generating an intervention signal.

Some embodiments provide for a non-transitory computer-readable storage medium storing processor executable instructions that when executed by at least one computer hardware processor enforce safe operating limits of a robotic system, wherein the processor executable instructions cause the at least one computer hardware processor to: receive sensor data from the plurality of sensors; generate control signals for controlling the plurality of actuators; determine whether the control signals exceed safe operating limits; and upon determining the control signals exceed the safe operating limits, generate an intervention signal.

In some embodiments, the plurality of actuators is configured in a plurality of kinematic chains, wherein each kinematic chain includes a respective common electrical bus electrically coupled to each actuator of the plurality of actuators.

In some embodiments determining the control signals exceed the safe operating limits comprises: receiving the control signals and sensor data from the plurality of sensors; estimating operational parameters for the plurality of actuators based on the received control signals; and determining that the control signals exceed the safe operating limits when the operating conditions deviate from the estimate operational parameters by a threshold tolerance.

In some embodiments, the processor executable instructions further cause the at least one computer hardware processor to: identify an alternative pose that involves a different position than a target pose; initialize a transition to the alternative pose based on the intervention signal; and after execute the transition to the alternative pose, initializing a transition back to the target pose.

In some embodiments, initializing a transition to the alternative pose comprises selecting an alternative policy.

In some embodiments, initializing a transition to the alternative pose comprises providing an alternative command to an active policy.

In some embodiments, determining the control signals exceed the safe operating limits comprises: determining whether the operating conditions exceed the safe operating limits; and upon determining that the operating conditions exceed the safe operating limits, modifying the control signals to limit the operating conditions to the safe operating limits based on the intervention signal.

In some embodiments, the processor executable instructions further cause the at least one computer hardware processor to alert a user that the operating conditions exceeded the safe operating limits and that the control signals are being limited.

In some embodiments, alerting the user that the operating conditions exceeded the safe operating limits include activating a plurality of LEDs of the robotic system.

In some embodiments, alerting the user that the operating conditions exceeded the safe operating limits include alerting a remote user with an error tone.

In some embodiments, modifying the control signals to limit the operating conditions to the safe operating limits comprises generating an override signal for an active task.

In some embodiments, the override signal stops execution of the active task and instructs the robotic system to place and release a carried object to decrease a load from the carried object on the robotic system.

In some embodiments, the override signal instructs the robotic system to redistribute a load of a carried object from a first subset of the plurality of actuators to a second subset of the plurality of actuators.

In some embodiments, the override signal instructs the robotic system to redistribute a load of a carried object by bracing the carried object against a housing of the robotic system.

In some embodiments, the processor executable instructions further cause the at least one computer hardware processor to execute a visio-temporal model to analyze output from a vision subsystem of the robotic system, wherein the visio-temporal model classifies objects in an environment of the robotic system as load-bearing or non-compatible relative to a weight of the robotic system.

In some embodiments, the override signal instructs the robotic system to brace the robotic system against a load-bearing object.

In some embodiments, the override signal instructs the robotic system to use a load-bearing object as a counterbalance.

In some embodiments, determining the control signals exceed the safe operating conditions comprises: comparing the operating conditions to the safe operating limits to determine whether the operating conditions exceed the safe operating limits; and upon determining that the operating conditions exceed the safe operating limits, initializing a transition from an active first policy to an alternative policy.

In some embodiments, the processor executable instructions further cause the at least one computer hardware processor to initialize a transition to the first policy when operational parameters of the first policy can be executed within the safe operating limits.

In some embodiments, the safe operating limits comprise a maximum operating temperature of each actuator in the plurality of actuators.

In some embodiments, the comparing the operating conditions to the safe operating limits to determine whether the operating conditions exceed the safe operating limits comprises comparing a thermal heating associated with the control signals and corresponding actuators with a heat capacitance of the corresponding actuators and when the thermal heating would exceed the maximum operating temperature, initializing a transition to the alternative policy.

In some embodiments, the safe operating limits comprise a maximum operating current of the plurality of actuators and a battery status.

In some embodiments, the safe operating limits include a maximum operating current of the plurality of actuators associated with a normal battery status and a reduced operating current of the plurality of actuators associated with a low battery status.

In some embodiments, the processor executable instructions further cause the at least one computer hardware processor to execute a safety override policy that, when active, will override intervention signals and authorize control signals that exceed the safe operating limits of the robotic system.

In some embodiments, a user authorizes the safety override policy.

In some embodiments, the safety override policy is authorized by the robotic system to avoid collision between the robotic system and a user.

In some embodiments, the safety override policy is authorized by the robotic system to avoid collision between the robotic system and a household animal.

Some embodiments provide for a method of executing motor control of a robotic system, the method comprising using a computer processor to: receive commands based on a target pose; receive component data for the robotic system; estimate operating conditions for the robotic system; and process the estimated operating conditions and the commands using a trained machine learning model to generate control signals that comply with safe operating limits.

Some embodiments provide for a robotic system comprising: a computer processor configured to control power to a plurality of actuators and to process signals received from a plurality of sensors; and a non-transitory computer-readable storage medium storing processor executable instructions that when executed by the computer processor cause the computer processor to: receive commands based on a target pose; receive component data for the robotic system; estimate operating conditions for the robotic system; and process the estimated operating conditions and the commands using a trained machine learning model to generate control signals that comply with safe operating limits.

Some embodiments provide for a non-transitory computer-readable storage medium storing processor executable instructions that when executed by at least one computer hardware processor cause the at least one computer hardware processor to: receive commands based on a target pose for a robotic system; receive component data for the robotic system; estimate operating conditions for the robotic system; and process the estimated operating conditions and the commands using a trained machine learning model to generate control signals that comply with safe operating limits.

In some embodiments, estimating the operating conditions for the robotic system comprises estimating the current of a plurality of actuators.

In some embodiments, estimating the current of the plurality of actuators comprises estimating a current draw for respective actuators of the plurality of actuators based on an angular velocity, applied torque, resistance, torque constant, and efficiency of the respective actuator.

In some embodiments, the processor executable instructions further cause the at least one computer hardware processor to calculate a total current estimate for a subset of the plurality of actuators that share a common electrical bus.

In some embodiments, estimating the operating conditions for the robotic system comprises estimating the temperature of a plurality of actuators.

In some embodiments, estimating the temperature of the plurality of actuators comprises estimating a change in temperature of the respective actuators of the plurality of actuators based on a heating coefficient and a cooling coefficient for the respective actuator.

In some embodiments, the heating coefficient and the cooling coefficient for a respective actuator are estimated by: applying a test torque to a stalled actuator; collecting torque and temperature readings over a plurality of test torque applications; and estimating the heating coefficient and the cooling coefficient from change in the torque and temperature readings in response to the test torque applications.

### BRIEF DESCRIPTION OF FIGURES

Various aspects and embodiments of the application will be described with reference to the following figures. It should be appreciated that the figures are not necessarily drawn to scale. Items appearing in multiple figures are indicated by the same reference number in all the figures in which they appear.

FIG. 1A illustrates a robotic processing environment for orchestrating the operation of a robotic system, in accordance with some embodiments described herein.

FIG. 1B illustrates an example of the robotic processing environment including submodules that may be used by the robotic system to provide efficient functionality for executing a diverse range of processes, in accordance with some embodiments described herein.

FIG. 2 is an illustration of an example robotic system, in accordance with some embodiments described herein.

FIG. 3 illustrates a robotic system that includes a power distribution architecture that organizes actuators into kinematic chains, in accordance with some embodiments of the technology described herein.

FIG. 4 illustrates a method for enforcing safe operating limits in a robotic system, in accordance with some embodiments of the technology described herein.

FIG. 5 illustrates a method for determining whether control signals exceed safe operating limits by detecting deviations between expected and actual operating conditions, in accordance with some embodiments of the technology described herein.

FIG. 6 illustrates a system for motor control in a robotic system, in accordance with some embodiments of the technology described herein.

FIG. 7 illustrates a system diagram that depicts the interaction between a damage prevention module and a reasoner over time for managing pose transitions, in accordance with some embodiments of the technology described herein.

FIG. 8 illustrates a method for modifying control signals to limit operating conditions to safe operating limits, in accordance with some embodiments of the technology described herein.

FIG. 9 illustrates a system for thermal monitoring and damage prevention in a robotic system, in accordance with some embodiments of the technology described herein.

FIG. 10 illustrates a system diagram for a motor control architecture with damage prevention feedback, in accordance with some embodiments of the technology described herein.

FIG. 11 illustrates a method of executing motor control of a robotic system using a trained machine learning model, in accordance with some embodiments of the technology described herein.

FIG. 12 illustrates a system for motor control with integrated thermal and power monitoring, in accordance with some embodiments of the technology described herein.

FIG. 13 illustrates a method for determining a low energy pose, in accordance with some embodiments of the technology described herein.

FIG. 14 illustrates a method for determining a low energy pose based in part on an object held by the robotic system, in accordance with some embodiments of the technology described herein.

FIG. 15 illustrates an illustrative implementation of a special purpose computer system 1500, that may be specially programmed to improve over conventional systems, to be used in connection with any of the embodiments of the disclosure provided herein.

### DETAILED DESCRIPTION

### I. Introduction

Aspects of the present disclosure relate to systems and methods for enforcing safe operational limits on the control signals used to operate a robotic system in a human-centric environment to protect against damage to the robotic components. According to an aspect of the present disclosure, the robotic system generates an intervention signal when control signals exceed safe operating limits. The intervention signal may be used to signal a warning to a user and/or may cause the system to change poses or activities to restore the robotic system to operating within the safe operating limits. Some aspects of the present disclosure relate to monitoring the power usage of components of the robotic system. Other aspects of the present disclosure relate to monitoring the temperature of components of the robotic system. One or more aspects of the present disclosure may be used in combination with each other and/or may be used with additional systems and processes for controlling a robotic system in a human-centric environment.

Despite decades of innovation in automation technologies, there are still many challenges that inhibit the development of robotic systems for operation in human-centric environments. In particular, existing development has focused on robotic systems for industrial applications or for specific niche functionality. The inventors have recognized and appreciated that safe operation, efficient logic processing, and power management remain barriers to the development of robotic systems for operation in human-centric environments.

Unlike robotic systems designed for industrial applications which may be large and powerful enough to cause serious damage to property or persons, robotic systems for operation in human-centric environments need to be able to operate safely around people. The inventors have recognized and appreciated that when designing robotic systems for human-centric environments, form factors that are compatible with navigating shared spaces with humans such as homes, commercial areas, and/or public spaces provide limitations on the size of the robotic system. Therefore, hardware or processes that might be well suited for use in an industrial environment may be inappropriate in human-centric spaces.

Robotic systems employ actuators to control the positions of mechanical joints and enable movement of robotic components. The actuators convert electrical energy into mechanical motion, and during operation, the actuators experience various operating conditions including temperature changes, current draw, and mechanical loads. When actuators operate outside of safe operating limits, the elevated operating conditions may cause accelerated wear on the actuators, reduce the operational lifespan of the components, and increase the likelihood of component failure. Component failure during operation may result in damage to the robotic system and may pose safety risks in environments where the robotic system operates in proximity to humans or other objects.

Safe operating limits define thresholds for operational parameters such as temperature, current draw, and power consumption that, when respected, allow actuators to operate without experiencing conditions that may cause damage. Temperature limits are particularly relevant because actuators generate thermal energy during operation due to electrical resistance in motor windings and mechanical friction. When the temperature of an actuator exceeds a maximum operating temperature, the elevated temperature may degrade lubricants, damage insulation materials, and cause thermal expansion that affects the mechanical tolerances of the actuator. Similarly, current limits protect actuators and associated electrical components from excessive power draw that may cause overheating, voltage drops, or power system failures.

The inventors have recognized and appreciated that managing actuators to operate within safe operating limits presents challenges for robotic systems that perform diverse tasks with varying load requirements. Different activities may impose different levels of strain on actuators, and the cumulative effect of sustained operation may cause operating conditions to approach or exceed safe limits over time. Robotic systems may benefit from mechanisms that monitor operating conditions, detect when control signals would cause operating conditions to exceed safe limits, and take corrective action to protect the actuators and the robotic system from damage. Such mechanisms may include generating intervention signals, modifying control signals, transitioning between control policies, or alerting users when operating conditions approach unsafe levels.

The inventors have further recognized and appreciated that certain operating scenarios present particular challenges for maintaining actuators within safe operating limits. For example, when a robotic system holds an object in a particular position, the actuators supporting the load of the object experience sustained strain that causes thermal energy to accumulate, even when the robotic system is not actively moving. As another example, unexpected snags or collisions may cause actuators to experience resistance that exceeds expected operational parameters, resulting in elevated current draw and thermal stress as the actuators attempt to overcome the obstruction. As a further example, load intensive activities such as walking, carrying heavy objects, or maintaining demanding postures may cause cumulative thermal buildup across multiple actuators, where the combined effect of repeated movements or sustained effort causes operating conditions to gradually approach or exceed safe limits.

To improve the performance of robotic systems in these and other scenarios in human centric environments, the inventors have developed robotic systems and methods to detect deviations from safe operating conditions and to intervene to prevent damage or strain to the robotic system. In some embodiments, the robotic system may detect deviations between expected and actual operating conditions, transition to alternative poses or policies that reduce strain on affected actuators, or redistribute loads across different actuators to allow overheated components to cool while continuing operation. In some embodiments, the robotic system may model the power consumption and/or temperature change to components of the robotic system based on planned or actual control signals. In some embodiments, the robotic system may include policies for generating control signals to perform particular activities or tasks, where the policies include trained neural networks that are trained based on the power and/or temperature dynamics associated with the control signals generated by the neural networks.

### II. Robotic System

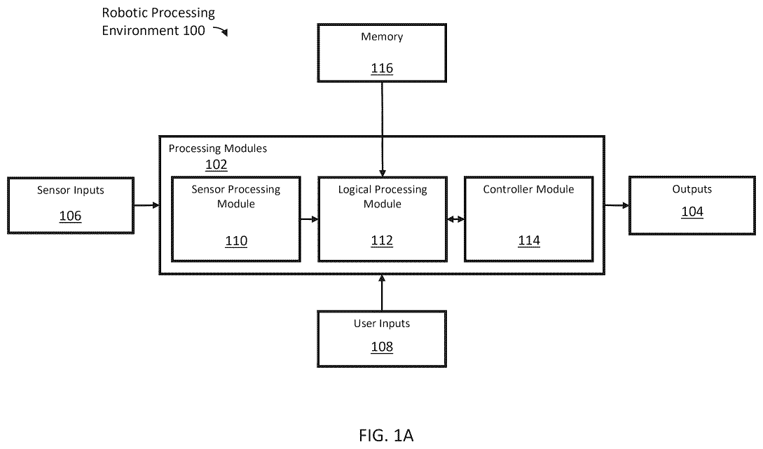

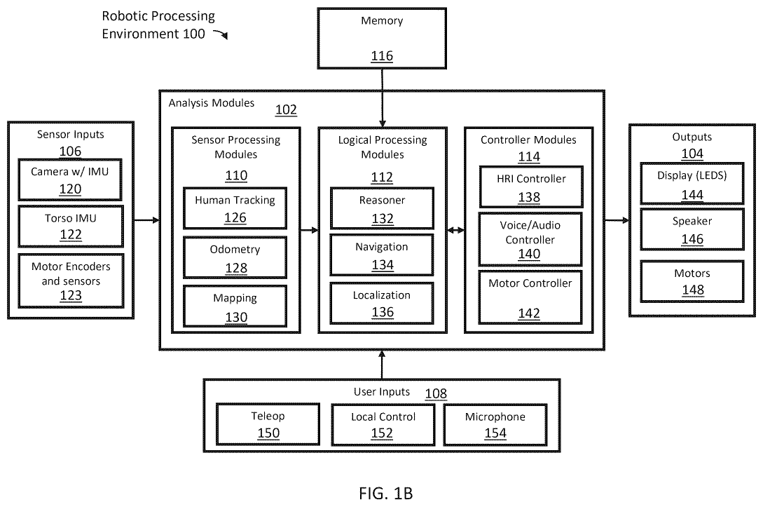

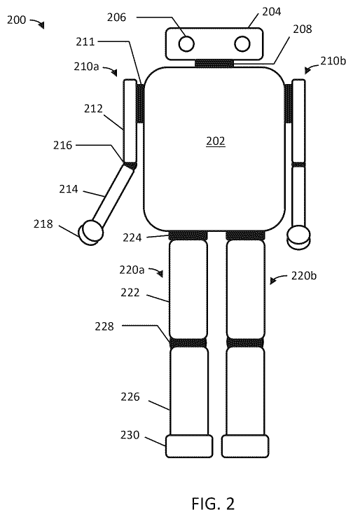

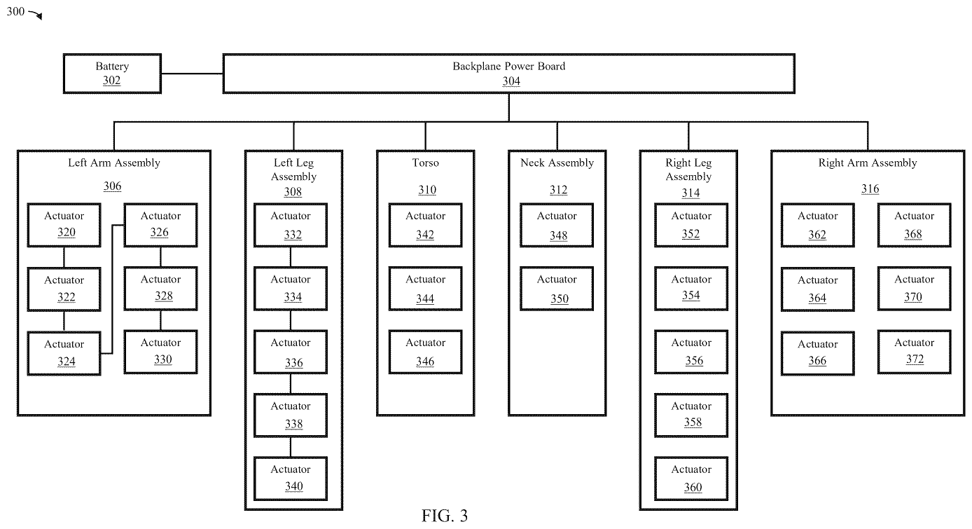

An example robotic system for implementing aspects of the technology described herein in human-centric environments is shown in FIG. 1A, FIG. 1B, FIG. 2, and FIG. 3.

FIG. 1A illustrates robotic processing environment 100 for orchestrating the operation of a robotic system, in accordance with some embodiments described herein. Robotic processing environment 100 includes processing modules 102 for interfacing with and controlling the physical hardware of the robotic systems. Additionally, processing modules 102 may execute analysis processes in connection with operation of the robotic system for executing routines or completing queries. Robotic processing environment 100 inputs sensor inputs 106, user inputs 108, and outputs 104.

Processing modules may include separate modules that may execute different routines using separate modules that can operate in parallel with specialization such that their respective functions are executed efficiently (e.g., with low latency and reduced power cost per task). In the illustrated example of FIG. 1A, the processing modules include sensor processing module 110, logical processing module 112, and controller module 114.

Sensor processing modules 110 may process the data received from sensor inputs 106 to convert the data stream into easy to process tokens. The sensor processing modules may use the data stream, or the resulting tokens, to update models and/or directories used by the robotic system. Alternatively, or additionally, the sensor processing modules may generate specific tokens, based on the data stream, for use by logical processing module 112.

Logical processing module 112 is responsible for executive reasoning, such as identifying tasks for execution by the robotic system and selecting routines, parameters for constraining the routines, cost functions for evaluating the routine execution, and other logic-based processes. The logical processing module 112 may access memory 116 for referencing one or more databases maintained by the robotic system. In some processes, the logical processing module 112 may select a routine and designate another module or hardware subsystem to execute the routine.

The logical processing module may receive inputs from instructions stored in memory 116, reference data stored in memory 116, live data directly from sensor inputs 106, processed live data from sensor processing module 110, and user inputs 108. The user inputs 108 may be facilitated by controller module 114 which may process the data received directly from the user input and may generate tokens, representative of the user input, for processing by the logical processing module 112.

The use of sensor processing module 110 and controller module 114 for generating tokens from the inputs received by sensors or users, respectively, may simplify the processing executed by the logical processing module. Accordingly, the sensor processing module and controller module may increase computation efficiency of intensive logical processes by reducing the complexity of the input data used in the logical analysis.

Additionally, controller module 114 may convert tokens output from the logical processing module into specific data streams for controlling the hardware systems and subsystems of the robotic system. The controller module 114 may provide that data stream through outputs 104.

Processing modules 102 receive sensor inputs 106 from the hardware sensors of the robotic system. The processing modules 102 may also receive user inputs 108 that include specific instructions for directly controlling the robot. Additionally, or alternatively, the user inputs may be queries that controller modules 114 process to generate a semantic understanding of the query which is then further processed by the logical processing modules 112 to identify and execute tasks that answer or respond to the query.

Although described at a general level with respect to FIG. 1A, the inventors have recognized and appreciated that the specific efficiency of process execution, and the corresponding modules used therein, may be highly process dependent. Accordingly, for specific processes, a specific subset of modules may be used to work in concert with each other to accurately and efficiently complete the task. Since one module may be actively used by several processes at once, each individual process may impact other processes being executed for basic or background tasks. Accordingly, each process should be designed so as not to disrupt the general functioning or its ability to maintain multiple active tasks that may be needed for responding to a single query.

FIG. 1B illustrates an example of the robotic processing environment 100 including submodules that may be used by the robotic system to provide efficient functionality for executing a diverse range of processes, in accordance with some embodiments described herein. The analysis modules 102 may receive different specific sensor inputs 106 depending on the process being executed. The robotic system may have different sensor subsystems that may separately communicate sensor data streams for use by the analysis modules 102. In the illustrated example of FIG. 1B, sensor inputs 106 include a camera with inertial measurement unit (IMU) 120, a torso IMU 122, motor encoders and sensors 123.

The camera with IMU 120 input may include input from any imaging system suitable for determining or approximating distances. For example, the imaging system may be stereo cameras, a time-of-flight sensor(s), a structured light scanner, and/or lidar. The camera with IMU 120 is not limited to having a single imaging system, the camera with IMU 120 input may include multiple visual systems. For example, stereo cameras may be configured for capturing images in front of a head sub-system of the robotic system while multiple time-of-flight sensors may be arranged around the robotic system to capture proximity measurements in each direction around the robotic system. As another example, the camera with IMU 120 may include a single imaging system such as a stereo camera.

Additionally, the camera with IMU 120 input may include IMU measurements that provide data on the pose of the robotic system and by extension the position of the camera of the robotic system. For example, the camera may be installed in a head subsystem that includes actuators to rotate and tilt the head subsystem to aim the camera in different directions around the robotic system.

Torso IMU 122 input may include IMU measurements that provide data on the pose of the torso of the robotic system. For example, as will be discussed in greater detail with reference to FIG. 2, the robotic system may include a torso unit to which arm, leg, and head subsystems are attached. The torso IMU input 122 may provide data on the overall pose of the robotic system.

Motor encoders and sensors 123 may include signals related to movement and/or load of the robotic system. Encoders may provide signals related to the position of actuators of the robotic system. For example, an arm subsystem may include several actuators positioned in different joints of the arm subsystem (e.g., shoulder, elbow, wrist, manipulator) encoders may provide signals corresponding to the position of the actuators and by extension, the position of the arm subsystem. Additionally, sensors such as temperature sensors may be configured to detect the temperature of the actuators in the robotic system. The temperature of an actuator is related to the load or stress upon the actuator. Thus, the temperature sensors may be used to determine a load upon an arm subsystem of the robotic subsystem. Although the provided examples describe actuators in an arm subsystem, a person of skill in the art would understand that other subsystems of the robotic system may generate signals from respective encoders and sensors that would be included with motor encoders and sensor input 123.

With respect to analysis modules 102, sensor processing modules 110 may include submodules for tracking humans 126, odometry 128, and environmental mapping 130. The human tracking submodule 126 may process sensor inputs 106 to detect and store actions of, or interactions with, people around the robotic system. Odometry submodule 128 may process sensor inputs 106 to determine a position of the robotic system based on data from the leg subsystems of the robotic system. Environmental mapping may generate a map of the area around the robotic system.

In some embodiments, the sensor processing modules 110 submodules may receive outputs from one or more other submodules. For example, odometry module 128 may receive camera with IMU input 120 and torso IMU 122 to determine odometric based position. The odometric based position may be provided to mapping and localization submodule 130 along with the unprocessed camera with IMU input 120 and torso IMU 122 data such that the mapping and localization submodule 130 generates a map of the area around the robotic system.

The mapping and localization submodule 130 may receive output from the odometry submodule 128 to determine a position of the robotic system relative to the environment around it. The mapping and localization submodule may provide the position of the robotic system to the navigation submodule 134 which may generate instructions for the controller modules 114 to perform specific actions or processes connected with movement of the robotic system around the environment.

Logical processing modules 112 may include submodules for logical reasoning 132 and navigation 132. The logical reasoning submodule 132 may generate high level commands for execution by the robotic system that then may be processed into execution signals by controller submodules. In some embodiments, the logical reasoning submodule may be used to execute aspects of the methods described herein.

Controller modules 114 may include submodules for human-robot interaction 138, voice/audio processing 140, motor movement 142. Human-robot interaction submodule 138 may interface with outputs 104 to communicate messages to users. For example, human-robot interaction submodule 138 may interface with display LEDs 144 and/or speaker 146 to communicate visual and/or audio messages to users, respectively. Voice/audio submodule 140 may use natural language processing to process audio inputs and to generate semantic audio outputs. For example, voice/audio submodule 140 may receive user input through microphone 154 and may output semantic audio responses generated using speaker 146.

Motor submodule 142 may generate signals for controlling movement of the robotic system through motor output 148. Motor submodule 142 may receive instructions for executing movement of the robotic system from logic reasoning submodule 132 or navigation submodule 134. The motor submodule 142 may generate signals for controlling actuators to cause movement of the robotic system.

In some embodiments, user inputs may directly interface with motor submodule 142 to remotely pilot the robotic system. For example, motor submodule may receive directional movement instructions from a controller communicatively coupled with the robotic system through local network connections. In some embodiments, a Bluetooth connection may be used to connect local controller 152 to motor controller 142. As another example, teleoperation submodule 150 may receive instructions from a remote location through a network connection, such as the Internet. Teleoperation submodule 150 may allow users to remotely connect to the robotic system to provide movement instructions for the robotic system.

Although illustrated as separate subsystems and submodules, a person of ordinary skill in the art would understand that implementations of the robotic system are not limited to the specific separation of components and modules described herein. In some implementations, certain modules or subsystems may be combined or further separated into designated submodules, as aspects of the technology described herein are not limited in this respect.

FIG. 2 is an illustration of an example robotic system 200, in accordance with some embodiments described herein. Robotic system 200 is assembled with a humanoid form factor. Accordingly, the robotic system includes a torso unit 202 with a head unit 204 that is connected to the torso unit through neck coupling 208. Robotic system 200 further includes limb units such as arm units 210a and 210b and leg units 220a and 220b for manipulation and locomotion. Arm units 210a and 210b may be connected to torso unit 202 through shoulder couplings 221. Similarly, leg units 220a and 220b may be connected to torso unit 202 through leg/hip couplings 224.

Head unit 204 includes a vision subsystem for providing visual inputs to the robotic system. The vision subsystem may include cameras or sensors for acquiring depth information of the area around the robotic system. In the illustrated embodiment of FIG. 2, the vision subsystem includes a stereo depth camera that uses a binocular vision system 206. Binocular vision system 206 is positioned on the front of the head unit giving the appearance of eyes. In some embodiments, additional sensors may be included in the vision system such as time-of-flight sensors and/or LIDAR sensors. The additional sensors may be embedded in the head unit and/or embedded in other units such as the torso unit 202.

Neck coupling 208 includes one or more actuators for moving the head unit 204 relative to torso unit 202. The one or more actuators may provide movement along multiple axes, for example by rotating and tilting to change the field of view of the vision subsystem. In some embodiments, neck coupling 208 includes two actuators for providing rotation and tilting of head unit 204.

Torso unit 202 includes one or more actuators for moving limbs relative to the torso or moving the torso relative to the limbs. In some embodiments, torso unit 202 includes an actuator for each arm unit 210a and 210b configured at a shoulder coupling between the arm units and the torso to rotate the arm units relative to the torso. In some embodiments, torso unit 202 includes an actuator between the torso unit and the couplings of the leg units, such that the torso unit can be rotated, relative to the legs, without requiring movement of the legs.

Arm units 210a and 210b include multiple components linked through articulable couplings. In the illustrated embodiment of FIG. 2, an arm unit includes an upper arm portion 212, a lower arm portion 214, and a gripper 218. The upper arm portion 212 is connected to the torso unit 202 through shoulder coupling 211, and the upper arm portion 212 is connected to the lower arm portion 214 through elbow coupling 216. The gripper 218 is connected to the end of lower arm portion 214.

The arm unit may include multiple actuators in the articulable couplings between the arm unit components such that the arm can be moved along multiple axis of rotation at each of the articulable couplings. For example, the arm unit may include multiple actuators adjacent to the shoulder coupling to tilt and rotate the arm unit relative to the shoulder coupling 211. The elbow coupling 216 may include multiple actuators to tilt and rotate the lower arm portion 214 relative to the upper arm portion 212. Additionally, multiple actuators may be configured between gripper 218 and lower arm portion 214 to tilt and rotate the grippers relative to the lower arm portion 212. Finally, one or more actuators may be included in the grippers to enable the gripper to pick up, release, or otherwise interact with objects.

Additionally, leg units 220a and 220b include multiple components linked through articulable couplings. In the illustrated embodiment of FIG. 2, a leg unit includes an upper leg portion 222, a lower leg portion 226, and a foot 230. The upper leg portion 222 is connected to torso unit 202 through leg/hip coupling 224, and the upper leg portion 222 is connected to the lower leg portion 226 though knee coupling 228. The foot 230 is connected to the end of lower leg portion 226.

The leg unit may include multiple actuators in the articulable couplings between the leg unit components such that the leg can be moved along multiple axes of rotation at each of the articulable couples. For example, the leg unit may include multiple actuators in the leg coupling to tilt and rotate the leg unit relative to the torso unit 202. The knee coupling 228 may include multiple actuators to tilt and rotate the lower leg portion 226 relative to the upper leg portion 222. Additionally, multiple actuators may be configured between foot 230 and lower leg portion 226 to tilt and rotate the foot relative to the lower leg portion.

In some embodiments, additional actuators or other means of producing motion of the robotic components may be included in foot 230 to adjust positions of components in the foot as the robotic system moves.

The actuators described in connection with FIG. 2 may be implemented using any suitable type of actuators that is rated for the power, load, and speed requirements of the robotic system. Additionally, in some embodiments, the actuators associated with different units of the robotic system may share a common electrical bus. As will be discussed further below, policies may determine control signals based on the power draw across common electrical buses such components which work together to produce specific movements may be optimized according to the power consumption of each actuator connected to the common electrical bus. Thus, the power efficiency and component strain may be optimized for different policies of the robotic system by accounting for the electrical anatomy of the system.

FIG. 3 illustrates a robotic system 300 that includes a power distribution architecture that organizes actuators into kinematic chains, in accordance with some embodiments of the technology described herein. The robotic system 300 includes a battery 302 that provides electrical power to the robotic system 300. The battery 302 is electrically coupled to a backplane power board 304, which serves as a central power distribution hub for the robotic system 300. The backplane power board 304 distributes electrical power from the battery 302 to multiple body assemblies of the robotic system 300.

The backplane power board 304 is electrically coupled to six body assemblies: a left arm assembly 306, a left leg assembly 308, a torso 310, a neck assembly 312, a right leg assembly 314, and a right arm assembly 316. Each body assembly may be associated with a functional limb or body portion of the robotic system 300. The left arm assembly 306 and the right arm assembly 316 correspond to arm limbs of the robotic system 300, while the left leg assembly 308 and the right leg assembly 314 correspond to leg limbs of the robotic system 300.

In some embodiments, the power distribution architecture shown in FIG. 3 may correspond to the robotic system of FIG. 2. In such embodiments, left arm assembly 306 may correspond to arm unit 210b, right arm assembly may correspond to arm unit 210a, left leg assembly 308 may correspond to leg unit 220b, right leg assembly 314 may correspond to right leg unit 220a, torso assembly 310 may correspond to torso unit 202, and neck assembly 312 may correspond to neck coupling 208. Although the illustrated example of FIG. 3 includes six assemblies as part of the electrical anatomy of the system, other examples may have different numbers of assemblies for the same number of components of the robotic system and/or may include additional components beyond those shown in FIGS. 2 and 3. Accordingly, the robotic system may have different electrical anatomical configurations in different kinematic chains, as aspects of the technology described herein are not limited in this respect.

With continued reference to FIG. 3, each body assembly contains a plurality of actuators configured in kinematic chains. The left arm assembly 306 includes an actuator 320, 322, 324, 326, 328, and 330 in an arm kinematic chain. The actuators 320, 322, and 324 may be arranged above and including an elbow joint and the actuators 326, 328, and 330 may be arranged below the elbow join. Each of the actuators 320, 322, 324, 326, 328, and 330 may be part of the same kinematic chain within the left arm assembly 306.

The left leg assembly 308 includes an actuator 332, an actuator 334, an actuator 336, an actuator 338, and an actuator 340 arranged in a leg kinematic chain. The actuators 332, 334, and 336 may be arranged above and including a knee joint and the actuators 338 and 340 may be arranged below a knee joint.

The torso 310 includes an actuator 342, 344, and 346 arranged in a torso kinematic chain. The neck assembly 312 includes an actuator 348 and 350 arranged in a neck kinematic chain. The right leg assembly 314 includes an actuator 352, 354, 356, 358, and 360 arranged in a leg kinematic chain. The right arm assembly 316 includes actuators 362, 364, 366, 368, 370, and 372. The right leg assembly and right arm assembly may be configured substantially identically with the correspond left leg assembly and left arm assembly, respectively.

Each kinematic chain includes a respective common electrical bus electrically coupled to each actuator within the kinematic chain. The actuators within a kinematic chain share the common electrical bus, which provides a finite current-carrying capacity for the actuators in that kinematic chain. The organization of actuators into discrete electrical buses allows the robotic system 300 to monitor and manage current draw at both individual actuator and bus levels.

As further shown in FIG. 3, the grouping of actuators into kinematic chains that share common electrical buses allows policy modules to learn behaviors that leverage the electrical anatomy of the robotic system 300. For a given behaviors or motion there may many different implementations for distributing the load across the actuators in the kinematic chain. Accordingly, the policy modules may develop behaviors or motions that produce a desired pose or movement without exceeding the operational parameters on any individual actuator in the kinematic chain. By distributing load across actuators within a kinematic chain, the policy modules may generate control signals that respect the current budget of the common electrical bus while achieving target poses or movements, as further describe herein.

### III. Enforcement of Safe Operating Limits

The robotic system may monitor operating conditions of actuators to determine when control signals would cause operating conditions to exceed safe operating limits and may take corrective action to protect the robotic system from damage. Corrective actions may include generating intervention signals that trigger transitions to alternative poses or policies, modify control signals to limit operating conditions, and/or alerting users that a given task or command would cause the operating conditions to exceed safe limits. These corrective actions apply both to tasks that include carrying objects and to unladen tasks or activities for reducing the load on actuators. The robotic system may also detect deviations between expected and actual operating conditions to identify situations where components may be snagged, caught, or under unexpected tension.

Safe operating conditions are conditions that prevent damage to the robotic system or components of the robotic system. Safe operating conditions are operational values for components of the robotic system that can be executed within the normal operating conditions of the component. For example, actuators may be rated for a range of positions, maximum velocity, maximum gain, maximum current, and/or maximum operating temperature. When operating temperature is exceeded, actuators may seize and stop moving. Accordingly, when the safe operating conditions are exceeded, use of the actuator may result in increased wear and/or failure of the component.

In some embodiments, safe operating conditions may include power consumption limits. Exceeding power consumption limits can cause a power failure in the robotic system which may cause the robotic system to lose control in during execution of an activity which can result in damage to the robotic system or danger caused when objects fall from the robotic systems control. In some embodiments, safe operating conditions may include temperature limits for actuators. When the temperature of an actuator exceeds an operational limit for the actuator, the elevated temperature increases wear on the actuator and increases the chance of component failure.

In some embodiments, the safe operating limits may be set to be 95% of the actual damage threshold such that an intervention is initiated before the system has actually exceeded the damage threshold. In some embodiments, the safe operating limits may be set to be 90% of the actual damage threshold. In some embodiments, the safe operating limits may be set to be 85% of the actual damage threshold. In some embodiments, the safe operating limits may be set to be 80% of the actual damage threshold. In some embodiments, the safe operating limits may be set in a range from 75% to 99% of the actual damage threshold. The selection of a particular threshold percentage may depend on factors such as the sensitivity of the actuators, the criticality of the task being performed, the ambient operating conditions, or the desired balance between operational performance and component protection.

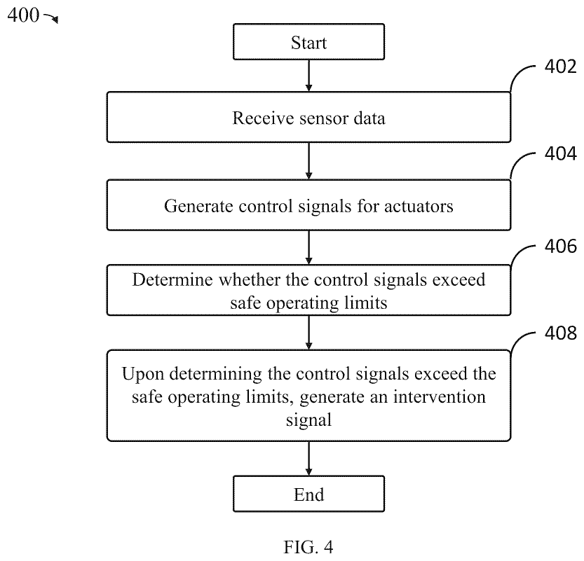

FIG. 4 illustrates a process 400 for enforcing safe operating limits in a robotic system, in accordance with some embodiments of the technology described herein. The method 400 may be executed by a processor configured to control power to a plurality of actuators and to process signals received from a plurality of sensors. The processor may execute processor executable instructions stored on a non-transitory computer-readable storage medium to perform processes to enforce safe operating limits of the robotic system.

Process 400 begins at a step 402, where sensor data is received from a plurality of sensors. The plurality of sensors may be configured to detect operating conditions of respective actuators of the plurality of actuators. The sensor data may include temperature readings, current measurements, position data, velocity data, and other operational parameters associated with the actuators. As described previously with reference to FIG. 1B, the motor encoders and sensors 123 may provide signals related to movement and load of the robotic system, including temperature sensors configured to detect the temperature of actuators.

The process 400 proceeds to act 404, where control signals are generated for controlling the plurality of actuators. The plurality of actuators may be configured to control positions of a plurality of mechanical joints. The plurality of mechanical joints may be configured between components of the robotic system such that the components are movably connected, as shown in FIG. 2. In some embodiments, the control signals may specify torque values, position targets, velocity commands, or other parameters for controlling the actuators to achieve a target pose or movement of the robotic system. However, in other embodiments, the control signals may have any suitable format for providing control signals or instructions for generating control signals to components of the robotic system.

The process 400 continues to act 406, where a determination is made as to whether the control signals exceed safe operating limits. The safe operating limits may define thresholds for power consumption, actuator temperature, current draw, and/or other operational parameters that, when exceeded, may cause damage to the robotic system or components of the robotic system. The determination may involve comparing estimated operational parameters resulting from the control signals against the safe operating limits. The estimated operational parameters may be estimated using any suitable technique. Example methods for estimating operational parameters are discussed herein in connection with providing feedback to a policy module during training.

As further shown in FIG. 4, the method 400 proceeds to act 408, where upon determining that the control signals exceed the safe operating limits, an intervention signal is generated. In some embodiments, the intervention signal may trigger corrective actions to protect the robotic system from damage. For example, the intervention signal may cause the robotic system to modify the control signals, transition to an alternative policy, alert a user, or take other protective measures. By generating the intervention signal when control signals exceed safe operating limits, the method 400 provides a mechanism for preventing damage to the robotic system or components of the robotic system during operation.

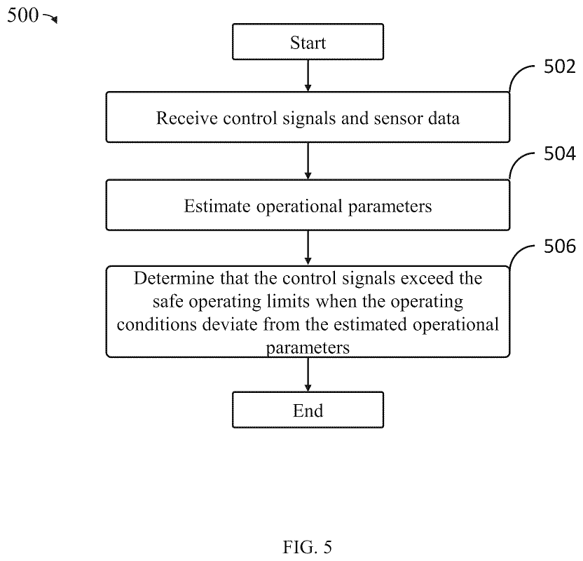

FIG. 5 illustrates a method 500 for determining whether control signals exceed safe operating limits by detecting deviations between expected and actual operating conditions, in accordance with some embodiments of the technology described herein. The robotic system may model expected operating conditions that result from executing control signals and may use deviations between the expected and actual operating conditions to determine that a component of the robotic system is snagged on something, collided with something, or under unexpected tension.

Process 500 begins at act 502, where the robotic system receives control signals and sensor data. The control signals may be generated for controlling the plurality of actuators, as described previously with reference to FIG. 4. The sensor data may be received from the plurality of sensors configured to detect operating conditions of respective actuators of the plurality of actuators. In some embodiments, the sensor data may include position data, velocity data, current measurements, torque readings, and other operational parameters associated with the actuators.

Process 500 proceeds to act 504, where the robotic system estimates operational parameters for the plurality of actuators based on the received control signals. The estimated operational parameters may represent the expected operating conditions that are expected from executing the control signals. For example, the robotic system may estimate expected torque values, expected current draw, expected position changes, and/or expected velocity profiles based on the control signals and a model of the robotic system dynamics. The estimation may account for the mechanical properties of the actuators, the kinematic configuration of the robotic system, and the movements specified by the control signals. The estimated operational parameters may be determined using any suitable method, including the example methods described below in accordance with modeling power and temperature for training machine learning models.

Process 500 continues to act 506, where the robotic system determines that the control signals exceed the safe operating limits when the operating conditions deviate from the estimated operational parameters by a threshold tolerance. The operating conditions may be determined from the sensor data received at act 502. The comparison may involve calculating differences between the estimated operational parameters and the actual operating conditions detected by the sensors. For example, the robotic system may compare an estimated torque value to an actual torque measurement, or may compare an estimated position to an actual position reading from an encoder. When the deviation exceeds the threshold tolerance, the robotic system may determine that an unexpected condition has occurred that warrants intervention.

Based on unexpected resistances detected through the comparison at act 506, the robotic system may infer that a component of the robotic system is obstructed or caught on an object. For example, if an actuator experiences higher than expected torque while attempting to move to a target position, the robotic system may determine that the corresponding limb or component has encountered an obstruction. Similarly, if an actuator fails to achieve an expected velocity despite receiving appropriate control signals, the robotic system may infer that the component is snagged on an object in the environment. The detection of such unexpected resistances through deviation analysis allows the robotic system to identify situations where components may be caught, collided, or under unexpected tension, enabling the robotic system to generate an intervention signal and take corrective action to protect the robotic system from damage.

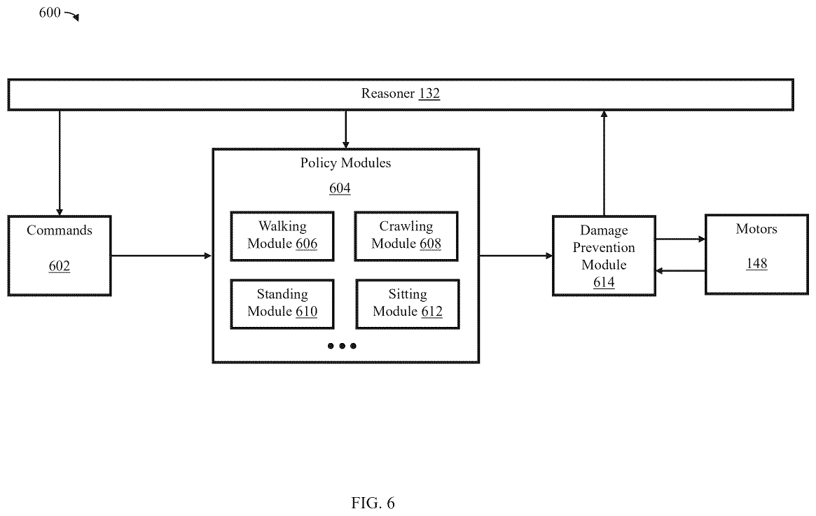

The methods 400 and 500 described above may be implemented using various system architectures that incorporate damage prevention functionality into the motor control pipeline. An example system architecture for implementing the enforcement of safe operating limits is illustrated in FIG. 6.

FIG. 6 illustrates a system 600 for motor control in a robotic system, in accordance with some embodiments of the technology described herein. The system 600 includes a reasoner 132, commands 602, policy modules 604, a damage prevention module 614, and motors 148. The system 600 provides an architecture for processing commands and generating control signals for the motors 148 while enforcing safe operating limits through the damage prevention module 614.

The commands 602 provide input to the policy modules 604. The commands 602 may specify target poses, movements, or behaviors for the robotic system to execute. The commands 602 may be generated by higher-level planning modules, user inputs, or autonomous decision-making processes of the robotic system. The policy modules 604 receive commands 602 and generate appropriate control outputs based on the selected module. The commands 602 may be associated with completing a task requested by a user. For example, reasoner 132 may decompose a task requested by a user into a sequence of commands 602 to be executed by the robotic system. Policy modules 604 includes a series of policy modules for controlling the movement or actions of the robotic system.

With continued reference to FIG. 6, The policy modules 604 include multiple specialized control modules for different locomotion or postural behaviors of the robotic system. The policy modules 604 include a walking module 606, a crawling module 608, a standing module 610, and a sitting module 612. Additional modules may be included in the policy modules 604 beyond those explicitly shown. Each module within the policy modules 604 corresponds to a different locomotion or postural behavior of the robotic system.

The walking module 606 may generate control signals for walking locomotion of the robotic system. The crawling module 608 may generate control signals for crawling locomotion of the robotic system. The standing module 610 may generate control signals for maintaining a standing posture of the robotic system. The sitting module 612 may generate control signals for maintaining a sitting posture of the robotic system. The reasoner 132 encompasses the policy modules 604 and coordinates the selection and execution of appropriate policies based on the incoming commands 602. The reasoner 132 and/or commands 602 may specify one or more policy modules for execution by the robotic system.

As an example of the selection of a policy module in connection with task execution, a user may provide a task to the robotic system to retrieve an object for the user. The reasoner 132 may decompose the task into discrete commands for locating the object, navigating to the object, lifting the object, and navigating with the object back to the user. commands 602 may specify navigating to the object and the reasoner may select walking module 606 or crawling module 608 depending on the location of the object and the operating conditions. Crawling may be a lower risk locomotion than walking when operating in a low power mode because if the robotic system loses power and freezes in a crawling position, the robotic system may be more stable and less likely to be damaged by falling over from a standing position. The policy modules 604 may include any number of additional specialized and/or general policy modules for controlling the components of the robotic system.

As further shown in FIG. 6, the outputs from the policy modules 604 are directed to the damage prevention module 614. In some embodiments, the damage prevention module 614 serves as an intermediary layer between the policy outputs and the physical actuators to enforce operational constraints. The damage prevention module 614 evaluates the control signals to determine whether the control signals comply with safe operating limits.

The damage prevention module 614 may modify or intervene with the control signals as to protect the robotic system from damage. When the damage prevention module 614 determines that control signals would cause operating conditions to exceed safe operating limits, the damage prevention module 614 may modify the control signals to limit the operating conditions to the safe operating limits. In some embodiments, the safe operating limits may be static values based on the properties of the components. In some embodiments, the safe operating limits may depend on a current status of the components. For example, actuators may be able to sustain a high load operation for a brief period of time and may similarly be resilient to high temperature spikes but be sensitive to elevated temperatures over time. Accordingly, the safe operating limits may depend on the thermal load and/or time at an elevated temperature. The damage prevention module 614 may generate intervention signals that trigger transitions to alternative policies, modifications to control signal parameters, or other protective measures.

The motors 148 receive the processed control signals from the damage prevention module 614 and execute the corresponding mechanical movements. By positioning the damage prevention module 614 between the policy modules 604 and the motors 148, the system 600 provides a mechanism for evaluating and modifying control signals before the control signals are executed by the motors 148. This arrangement allows the robotic system to generate control signals through the policy modules 604 while maintaining protection against operating conditions that may cause damage to the robotic system or components of the robotic system.

Alternatively, or additionally, initializing a transition to the alternative pose may comprise providing an alternative command to an active policy. Rather than switching from one policy module to another policy module, the reasoner 132 may provide modified commands to the currently active policy module. The active policy module may then generate control signals based on the alternative command to achieve the alternative pose. For example, the reasoner 132 may provide an alternative command to the sitting module 612 that specifies a modified target position, causing the sitting module 612 to generate control signals for transitioning to the alternative pose without switching to a different policy module. This approach allows the robotic system to achieve pose transitions while maintaining the active policy module and modifying the commands provided to that policy module

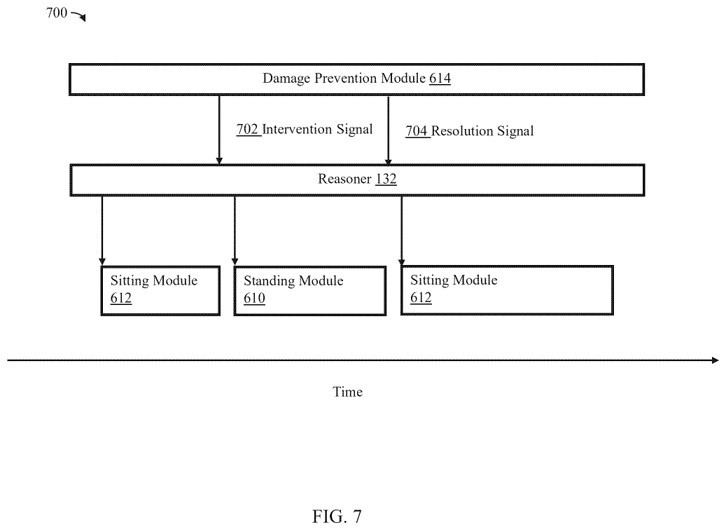

FIG. 7 illustrates a system diagram 700 that depicts the interaction between the damage prevention module 614 and the reasoner 132 over time for managing pose transitions, in accordance with some embodiments of the technology described herein. The system diagram 700 illustrates how the damage prevention module 614 communicates with the reasoner 132 to trigger transitions between different policy modules in response to detected conditions that may exceed safe operating limits.

The damage prevention module 614 communicates with the reasoner 132. An Intervention Signal 702 is transmitted from the damage prevention module 614 to the reasoner 132 when the damage prevention module 614 determines that control signals exceed safe operating limits. In some embodiments, a Resolution Signal 704 is transmitted from the damage prevention module 614 to the reasoner 132 when the condition that triggered the Intervention Signal 702 has been resolved.

In the example of FIG. 7, a temporal sequence along a time axis shows the reasoner 132 directing operation through different policy modules for responding to an unexpected snag or collisions. The reasoner 132 initially directs operation through the sitting module 612. If the robotic system experiences an unexpected collision when in the seated position or when transitioning to the seated position, the reasoner 132 may indicate that the robotic system needs to reposition by providing an Intervention Signal.

To resolve an obstruction detected through deviation between expected and actual operating conditions, as described previously with reference to FIG. 5, the robotic system may transition to a neutral position as a geometric reset. The standing module 610 may provide control signals for achieving the neutral position. By transitioning to the neutral position, the components of the robotic system have a chance to settle back into the target position unobstructed. The neutral position may allow components that were snagged, caught, or under unexpected tension to disengage from obstructions in the environment.

After the robotic system executes the transition to the alternative pose through the standing module 610, the damage prevention module 614 may transmit the Resolution Signal 704 to the reasoner 132. The Resolution Signal 704 triggers a transition from the standing module 610 back to the sitting module 612.

Initializing a transition to the alternative pose may comprise selecting an alternative policy. In the example illustrated in FIG. 7, the reasoner 132 selects the standing module 610 as an alternative policy when the Intervention Signal 702 is received. The standing module 610 generates control signals that differ from the control signals generated by the sitting module 612, thereby achieving the alternative pose through a different set of motor commands. The selection of an alternative policy allows the robotic system to transition to a pose that may reduce strain on actuators, avoid obstructions, or otherwise address the condition that triggered the Intervention Signal 702.

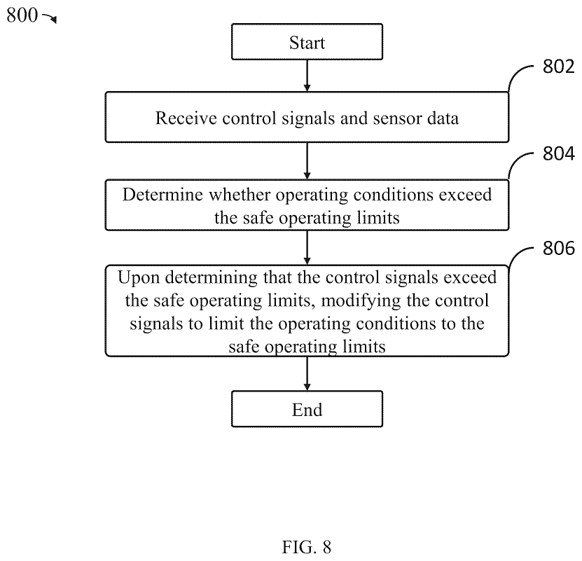

FIG. 8 illustrates a method 800 for modifying control signals to limit operating conditions to safe operating limits, in accordance with some embodiments of the technology described herein. The method 800 provides a process for the robotic system to modify control signals directly when operating conditions exceed safe limits. For example, an intervention signal generated in connection with process 800 may be an intervening control signal that is then provided to the actuators as an alternate to the control signals that exceed the safe operation limits. The method 800 may be executed by a processor configured to control power to a plurality of actuators and to process signals received from a plurality of sensors.

Process 800 begins at act 802, where the robotic system receives control signals and sensor data. The control signals may be generated for controlling the plurality of actuators, as described previously with reference to FIG. 4 and FIG. 5. The sensor data may be received from the plurality of sensors configured to detect operating conditions of respective actuators of the plurality of actuators. In some embodiments, the sensor data may include one or more of temperature readings, current measurements, position data, velocity data, torque readings, and other operational parameters associated with the actuators.

Process 800 proceeds to act 804, where the robotic system determines whether the operating conditions exceed the safe operating limits. The determination may involve comparing the operating conditions detected by the sensors to predefined safe operating limits. The safe operating limits may define thresholds for power consumption, actuator temperature, current draw, or other operational parameters that, when exceeded, may cause damage to the robotic system or components of the robotic system. Act 804 evaluates whether the current operating conditions of the robotic system fall within acceptable ranges defined by the safe operating limits.

Process 800 continues to act 806, where upon determining that the operating conditions exceed the safe operating limits, the robotic system modifies the control signals to limit the operating conditions to the safe operating limits. The modification of the control signals may involve adjusting torque values, reducing velocity commands, limiting position targets, or otherwise constraining the control signal parameters to bring the operating conditions within the safe operating limits. By modifying the control signals directly, process 800 allows the robotic system to continue executing an active task while constraining the operating conditions to prevent damage.

In some embodiments, modifying the control signals to limit the operating conditions to the safe operating limits may comprise generating an override signal for an active task. The override signal may instruct the robotic system to modify the execution of the active task in a manner that reduces the operating conditions to within the safe operating limits. For example, the override signal may specify modified parameters for the active task, such as reduced speed, limited range of motion, or decreased force application.

In some embodiments, the override signal may instruct the robotic system to manage carried objects to reduce load on actuators when operating conditions exceed safe operating limits. For example, when the robotic system is carrying an object and the damage prevention module determines that the load from the carried object causes operating conditions to exceed safe operating limits, the override signal may trigger various responses to address the excessive load condition.

In some embodiments, the override signal may stop execution of an active task and instruct the robotic system to place or release a carried object to decrease a load from the carried object on the robotic system. When the robotic system is executing a task that involves carrying an object, the actuators supporting the carried object may experience elevated temperatures, increased current draw, or other operating conditions that approach or exceed safe operating limits. In response to detecting such conditions, the damage prevention module may generate an override signal that halts the active task and directs the robotic system to find a suitable location to place the carried object. By placing and releasing the carried object, the robotic system removes the load from the actuators, allowing the operating conditions to return to within safe operating limits. The robotic system may then resume the active task once the load has been removed.

In some embodiments, the override signal may instruct the robotic system to redistribute a load of a carried object from a first subset of the plurality of actuators to a second subset of the plurality of actuators. Rather than placing and releasing the carried object, the robotic system may transfer the load to different actuators that have greater capacity or that are operating within safer margins relative to the safe operating limits. For example, if actuators in a first arm assembly are experiencing elevated temperatures from supporting a carried object, the override signal may instruct the robotic system to transfer the carried object to a second arm assembly. The second subset of actuators may have lower current temperatures, greater available current capacity, or other characteristics that allow the second subset of actuators to support the load without exceeding safe operating limits. By redistributing the load from the first subset of actuators to the second subset of actuators, the robotic system may continue carrying the object while allowing the first subset of actuators to recover (e.g., cool down) from the elevated operating conditions.

In some embodiments, the override signal may instruct the robotic system to redistribute a load of a carried object by bracing the carried object against a housing of the robotic system. The housing of the robotic system may provide structural support that reduces the load borne by the actuators. By bracing the carried object against the housing, the robotic system transfers a portion of the load from the actuators to the structural components of the housing. This redistribution may reduce the torque, current draw, and thermal stress experienced by the actuators while maintaining possession of the carried object. The housing may include surfaces of a torso unit, arm components, or other structural elements of the robotic system that can provide support for the carried object. Bracing the carried object against the housing allows the robotic system to continue holding the object while reducing the operating conditions of the actuators to within safe operating limits.

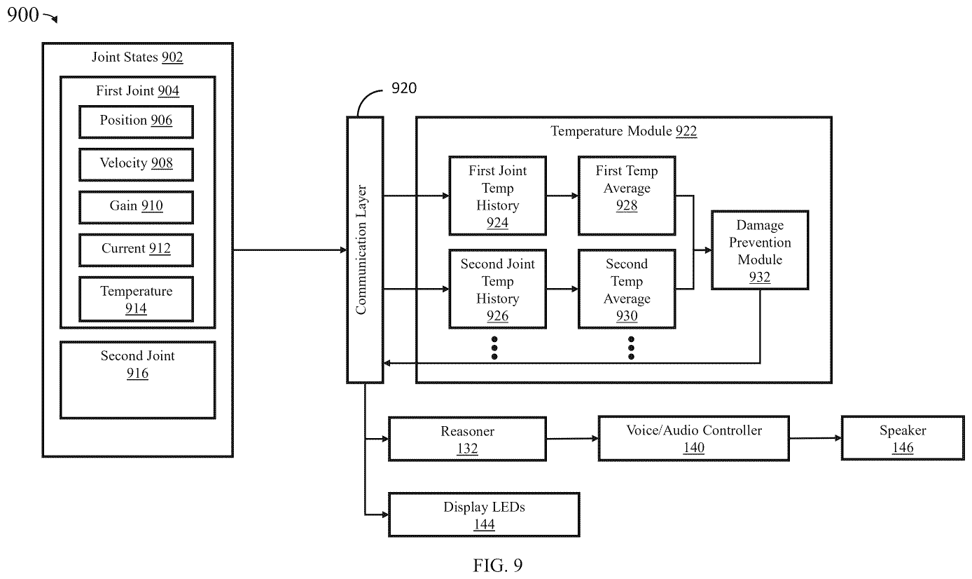

FIG. 9 illustrates a system 900 for thermal monitoring and damage prevention in a robotic system, in accordance with some embodiments of the technology described herein. The system 900 provides an architecture for monitoring temperature data from actuators and alerting users or remote users when operating conditions exceed safe operating limits. The system 900 includes joint states 902, a communication layer 920, a temperature module 922, the reasoner 132, the voice/audio controller 140, the display LEDs 144, and the speaker 146.

The joint states 902 includes operational data for actuators of the robotic system. The joint states 902 include data for a first joint 904 and a second joint 916. Additional joints may be included in the joint states 902 beyond the first and second joint. In some embodiments, the joint states 902 may include data for each joint in the robotic system.

The operational data my include signals produced by the actuator, such as signals produced form any encoders, and signals from sensors installed in the joint to measure properties of the actuator or the joint. In some embodiments, the first joint 904 includes multiple parameters that characterize the operational state of the corresponding actuator, including a position 906, a velocity 908, a gain 910, a current 912, and a temperature 914. The position 906 stores position data for the first joint 904, which may be obtained from encoders associated with the actuator. The velocity 908 stores velocity data for the first joint 904. The gain 910 stores gain parameters associated with control of actuators in the first joint 904. The current 912 stores current measurements for the first joint 904. The temperature 914 stores temperature readings for the first joint 904, which may be obtained from temperature sensors configured to detect the temperature of the actuator. The second joint 916 similarly stores corresponding joint state information including position, velocity, gain, current, and temperature parameters for a second joint of the robotic system.

Communication layer 920 provides an interface for transferring operational data between the hardware sensors and the processing modules of the system 900. In the illustrated example of FIG. 9, communication layer 920 facilitates data transfer between the data stream from joint states 902 to the temperature module 922. In some embodiments, the communication layer 920 may receive temperature data from the joint states 902 and transmit the temperature data from first joint 904 and second joint 916 to the temperature module 922 for processing.

Temperature module 922 processes temperature data from the joints 904 and 916 to store first joint temp history 924 that stores historical temperature data for the first joint 904 and second joint temp history 926 that stores historical temperature data for the second joint 916. The first joint temp history 924 and the second joint temp history 926 may store temperature readings collected over time, allowing the temperature module 922 to track temperature trends and changes for each joint.

Additionally, temperature module 922 processes the first and second joint temp history to generate a first temp average 928 and second temp average 930. The first temp average 928 and the second temp average 930 may provide smoothed temperature values that reduce the effect of transient temperature fluctuations. By computing average temperatures from historical data, the temperature module 922 may provide more stable temperature estimates for use in determining whether operating conditions exceed safe operating limits. In some embodiments, the first and second joint temp histories may be limited to a particular time or activity duration. For example, the first and second joint temp histories may be limited to 1 minutes, 2 minutes, 5 minutes, 10 minutes, 30 minutes, 1 hour, or greater than 1 hour and less than 1 day. As another example, the first and second joint temp histories may be limited to a particular battery change cycle or a particular task duration.

Damage prevention module 932 analyzes the temperature averages to determine whether operating conditions exceed safe thermal limits. When the damage prevention module 932 determines that operating conditions exceed the safe operating limits, the damage prevention module 932 may generate intervention signals and trigger appropriate responses to protect the robotic system from damage. The damage prevention module 932 may compare the temperature averages against maximum operating temperature thresholds defined for each actuator.

When the damage prevention module 932 determines that the average temperatures exceed the operating temperature thresholds defined for each actuator, the reasoner 132 receives an intervention signal from the temperature module 922. The reasoner 132 is connected to the display LEDs 144 for providing visual alerts to users. The reasoner 132 is also connected to the voice/audio controller 140, which in turn is connected to the speaker 146 for providing audible alerts regarding thermal status or warnings.

In some embodiments, system 900 may alert a user that the operating conditions exceeded the safe operating limits and that the control signals are being limited. When the damage prevention module 932 determines that operating conditions exceed safe thermal limits, the reasoner 132 may coordinate alerting the user through visual and audio outputs. Alerting the user that the operating conditions exceeded the safe operating limits may include activating a plurality of LEDs of the robotic system. The display LEDs 144 may be activated to provide visual feedback indicating that operating conditions have exceeded safe limits and that control signals are being modified. The display LEDs 144 may display patterns, colors, or sequences that communicate the nature of the thermal condition to the user. For example, the display LEDs 144 may flash orange to indicate that operation conditions have exceeded safe limits.

Alerting the user that the operating conditions exceeded the safe operating limits may also include alerting a remote user with an error tone. The error tone may be transmitted to a remote user through a network connection, allowing users who are not physically present near the robotic system to receive notification that operating conditions have exceeded safe limits. The error tone may indicate the type of condition detected, the severity of the condition, or other information relevant to the thermal status of the robotic system. By providing both visual alerts through the display LEDs 144 and audio alerts through the speaker 146, the system 900 allows the robotic system to communicate thermal conditions to users through multiple modalities.

The robotic system may include a visio-temporal model to analyze output from a vision subsystem of the robotic system. The vision subsystem may include cameras, depth sensors, or other imaging systems configured to capture visual information about the environment surrounding the robotic system. The visio-temporal model may process sequences of images or depth data captured by the vision subsystem to identify and characterize objects in the environment. In some embodiments, the visio-temporal model may include machine learning techniques trained on datasets that include various types of objects and their structural properties.

The visio-temporal model classifies objects in an environment of the robotic system as load-bearing or non-compatible relative to a weight of the robotic system. Load-bearing objects may include objects that have structural characteristics capable of supporting the weight of the robotic system or a portion of the weight of the robotic system. Examples of load-bearing objects may include walls, tables, countertops, sturdy furniture, railings, or other fixed or stable structures in the environment. Non-compatible objects may include objects that lack the structural integrity to support the weight of the robotic system, such as lightweight furniture, fragile items, unstable objects, or objects that may tip or collapse under applied force. The classification performed by the visio-temporal model may consider factors such as object geometry, estimated material properties, object stability, and spatial relationships between objects in the environment.

The visio-temporal model may analyze visual data to assess object stability and movement characteristics. In some embodiments, the visio-temporal model includes a trained neural network that classifies objects as structural or non-compatible. The classifications may be stored in memory and/or in a reference map of the environment that the robotic system may reference when looking for potential structural support.

In some embodiments, the visio-temporal model may continuously update classifications of objects in the environment as the robotic system moves through the environment or as objects in the environment change position. The updated classifications may allow the damage prevention module to identify available load-bearing objects when generating override signals in response to operating conditions that exceed safe operating limits. The integration of the visio-temporal model with the damage prevention module provides the robotic system with awareness of environmental support options that may be leveraged to manage excessive operating conditions without requiring the robotic system to abandon an active task or release a carried object.

When the damage prevention module determines that operating conditions exceed safe operating limits, as described previously, the override signal may instruct the robotic system to interact with load-bearing objects identified by the visio-temporal model. The override signal may instruct the robotic system to brace itself against a load-bearing object. Bracing against a load-bearing object may involve positioning a portion of the robotic system, such as an arm, leg, or torso component, against the load-bearing object to transfer a portion of the load from the actuators to the load-bearing object. By bracing against a load-bearing object, the robotic system may reduce the torque and current draw experienced by actuators that are approaching or exceeding safe operating limits. The load-bearing object may provide external support that supplements the structural support provided by the actuators, allowing the robotic system to maintain a pose or continue an activity while reducing the operating conditions of the actuators.

In some embodiments, the robotic system may use a load-bearing object as a counterbalance. Using a load-bearing object as a counterbalance may involve positioning the robotic system such that the load-bearing object provides a stabilizing force that offsets a load experienced by the actuators. For example, when the robotic system is carrying an object that causes actuators to experience elevated operating conditions, the robotic system may grip a load-bearing object such that the load-bearing object provides a counterbalancing force to allow the robotic system to exert larger forces on the object without losing balance or falling over.

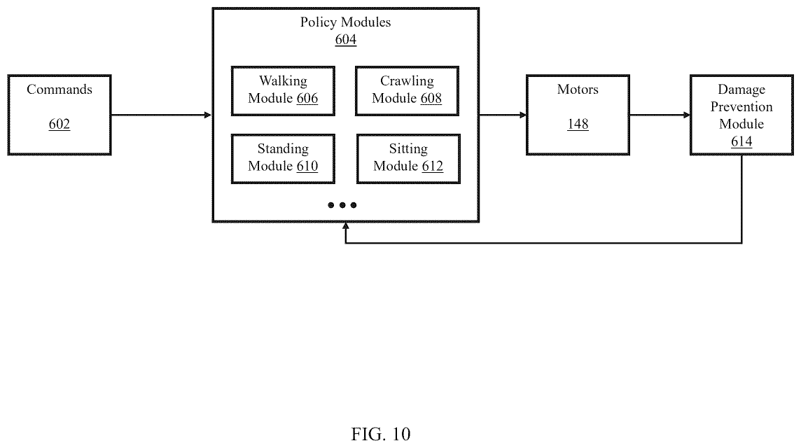

FIG. 10 illustrates a system diagram for a motor control architecture with damage prevention feedback, in accordance with some embodiments of the technology described herein. The damage prevention module 614 provides intervention signals to policy modules 604 to be used as an input such that the policy modules may account for the intervention signals when generating control signals for motors 148.

The commands 602 are received as input to the system and are directed to the policy modules 604. The commands 602 may specify target poses, movements, locomotion modes, or other behaviors for the robotic system to execute, as described herein in connection with FIG. 6 above.

The policy modules 604 process the commands 602 and generate appropriate control outputs based on the selected module within the policy modules 604. The policy modules 604 contain multiple specialized control modules for different locomotion or postural behaviors of the robotic system. The policy modules 604 include the walking module 606, the crawling module 608, the standing module 610, and the sitting module 612. Additional modules may be included in the policy modules 604 beyond those explicitly shown, as aspects of the technology described herein are not limited in this respect.

The outputs from the policy modules 604 are directed to the motors 148. The motors 148 execute the physical movements of the robotic system based on the control signals received from the policy modules 604. The motors 148 actuate the mechanical joints of the robotic system to achieve the poses and movements specified by the active module within the policy modules 604.

In the example of FIG. 10, sensors in the robotic system that detect data on motors 148 provide that data to the damage prevention module 614. The damage prevention module 614 monitors the operation of the motors 148 and detects operating conditions associated with the motors 148. In some embodiments, the damage prevention module 614 may monitor operating conditions such as temperature, current draw, torque, velocity, or other parameters to determine whether the motors 148 operate within safe limits. The damage prevention module 614 evaluates whether the operating conditions approach or exceed safe operating limits.

The damage prevention module 614 provides feedback to the policy modules 604, creating a feedback loop within the motor control architecture. The feedback loop from the damage prevention module 614 back to the policy modules 604 enables the system to adjust motor control behaviors based on conditions detected by the damage prevention module 614. When the damage prevention module 614 detects operating conditions that approach or exceed safe operating limits, the damage prevention module 614 may transmit signals to the policy modules 604 that influence the selection or behavior of the active module.

In some embodiments, the feedback from the damage prevention module 614 may cause the policy modules 604 to transition between different behavioral modes. For example, when the damage prevention module 614 detects that actuators are experiencing elevated temperatures during walking locomotion, the feedback may cause the policy modules 604 to transition from the walking module 606 to the standing module 610 or the sitting module 612. The transition to an alternative policy may reduce the load on the actuators and allow the actuators to cool down before resuming the original locomotion mode.

The robotic system may initialize a transition to back to the original policy module when operational parameters of the first policy can be executed within the safe operating limits. For example, once the actuators have cooled sufficiently during operation of the alternative policy, the robotic system may resume the original policy. By transitioning back to the first policy when conditions permit, the robotic system may continue executing the original task or behavior.

Accordingly, in some embodiments, high strain inducing activities may be executed in a piecewise fashion by switching between high load and low load policies without risking damage to the robotic system components. During the periods of reduced strain activity, the actuators may dissipate accumulated thermal energy and return to temperatures within the ideal operating range. This piecewise execution approach allows the robotic system to perform demanding tasks that would otherwise cause actuators to overheat if executed continuously.

The safe operating limits may comprise a maximum operating temperature of each actuator in the plurality of actuators. Each actuator may have a specified maximum operating temperature that defines an upper bound for safe operation. In some embodiments, the maximum operating temperature may be determined based on the thermal characteristics of the actuator, including the materials used in the actuator construction, the thermal dissipation properties of the actuator housing, and the rated operating specifications provided by the actuator manufacturer.

The safe operating limits may include a maximum operating temperature. In some embodiments, the maximum operating temperature may be a temperature lower than the damage threshold temperature, allowing the robotic system to proactively manage thermal conditions rather than reacting after overheating has occurred. A predictive comparison of thermal heating to heat capacitance may be used in some embodiments to anticipate thermal conditions and transition to the alternative policy or alternative position in advance of reaching unsafe temperatures.

The safe operating limits may also include a maximum operating current of the plurality of actuators and a battery status. The maximum operating current may define an upper bound for current draw that the actuators can sustain without exceeding thermal or electrical limits. The battery status may indicate the charge level, health, or capacity of a battery that provides electrical power to the robotic system. The combination of maximum operating current and battery status may provide the robotic system a process to adjust safe operating limits based on the available power capacity of the robotic system.

The safe operating limits may depend on battery status and may include a reduced maximum operating current when the robotic system has a low battery status. When the battery status indicates a normal charge level, the robotic system may permit actuators to draw current up to the maximum operating current. However, when the battery status indicates a low charge level, the robotic system may reduce the permitted current draw to a reduced operating current that is lower than the maximum operating current. The reduced operating current associated with low battery status may help preserve remaining battery capacity and prevent voltage drops that could cause system instability. By adjusting the safe operating limits based on battery status, the robotic system may adapt operation to the available power resources while maintaining protection against conditions that may cause damage to the robotic system or components of the robotic system.

In some embodiments, the robotic system may include a safety override policy that, when active, will override intervention signals and authorize control signals that exceed the safe operating limits of the robotic system. The safety override policy provides a mechanism for the robotic system to operate beyond normal safe operating limits in circumstances where exceeding the limits may be warranted to address urgent situations. Accordingly, when the safety override policy is active, the damage prevention module may permit control signals that would otherwise trigger intervention signals, allowing the robotic system to execute movements or apply forces that exceed the thresholds defined by the safe operating limits.

There may be circumstances where a user needs urgent assistance due to environmental danger. Such circumstances may include situations where something is falling on the user, where the user is injured and needs to be carried to safety, or where the user needs to be dragged to safety due to an inability to move independently. In such situations, the loads or forces involved in assisting the user may exceed the normal load limits of the robotic system. Under normal operation, the damage prevention module would generate intervention signals and limit control signals to prevent the robotic system from exceeding safe operating limits. However, the safety override policy allows the robotic system to exceed the safety parameters when authorized.

Exceeding the safety parameters may risk damage to the robotic system, but may prevent physical harm from occurring to the user.

A user may authorize the safety override policy. The authorization from the user may take various forms depending on the configuration of the robotic system and the urgency of the situation. In some embodiments, the authorization for safety override may involve a physical switch that must be activated as a hardwired feature. The physical switch may be positioned on the robotic system in a location accessible to the user. When the user activates the physical switch, the safety override policy becomes active and the robotic system may execute control signals that exceed the safe operating limits. The hardwired nature of the physical switch may provide a reliable mechanism for activating the safety override policy that does not depend on software processing or voice recognition systems.

In some embodiments, the authorization for safety override may involve verbal or other authorization from the user. The robotic system may include voice recognition capabilities that allow the user to speak a command or phrase that activates the safety override policy. The verbal authorization may be processed by a voice/audio controller of the robotic system, which may recognize the authorization command and activate the safety override policy in response. Other forms of authorization may include gesture recognition, activation through a mobile application, or other input modalities that allow the user to communicate authorization to the robotic system. The verbal or other authorization provides flexibility for users to activate the safety override policy in situations where physical access to a switch may not be practical.

The safety override policy may be authorized by the robotic system to avoid collision between the robotic system and a user. In addition to user-initiated authorization, the robotic system may autonomously activate the safety override policy in certain circumstances. For example, when the robotic system detects an imminent collision with a user, the robotic system may determine that exceeding safe operating limits is warranted to avoid the collision. The robotic system may use sensor data from vision systems, proximity sensors, or other detection mechanisms to identify situations where a collision with a user is likely to occur. In response to detecting the imminent collision, the robotic system may authorize the safety override policy and execute control signals that exceed the safe operating limits to perform evasive maneuvers or rapid movements that prevent contact with the user.

The safety override policy may be authorized by the robotic system to avoid collision between the robotic system and a household animal. Similar to the authorization for avoiding collision with a user, the robotic system may autonomously activate the safety override policy when the robotic system detects an imminent collision with a household animal. Household animals may include pets such as dogs, cats, or other animals that may be present in the operating environment of the robotic system. The robotic system may use vision systems or other sensors to detect the presence and movement of household animals in the environment. When the robotic system determines that a collision with a household animal is imminent, the robotic system may authorize the safety override policy and execute control signals that exceed the safe operating limits to avoid the collision. The authorization of the safety override policy to avoid collision with a household animal allows the robotic system to protect animals in the environment by performing rapid movements or applying forces that would otherwise be constrained by the safe operating limits.

### IV. Trained Machine Learning Model for Processing Operating Conditions

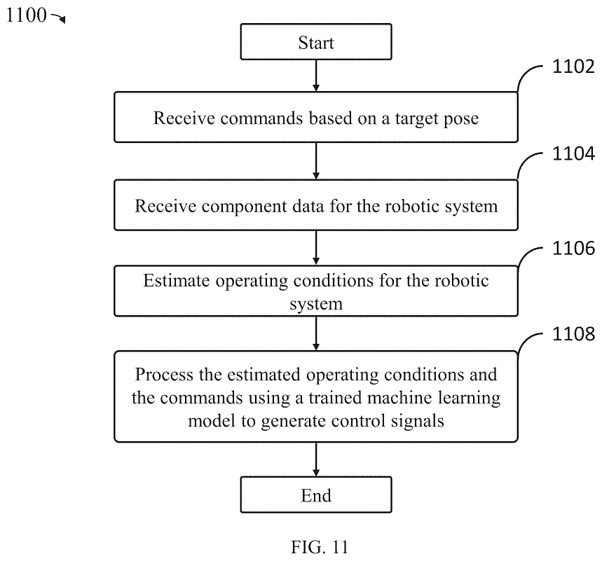

FIG. 11 illustrates a method 1100 of executing motor control of a robotic system using a trained machine learning model, in accordance with some embodiments of the technology described herein. The method 1100 uses operating conditions as input to a trained machine learning model to generate control signals that comply with safe operating limits. The method 1100 may be executed by a computer processor configured to control power to a plurality of actuators and to process signals received from a plurality of sensors.

The method 1100 begins at a step 1102, where the computer processor receives commands based on a target pose. The commands may specify a desired position, orientation, or configuration for the robotic system to achieve. The target pose may define positions for mechanical joints of the robotic system, orientations of limb assemblies, or other spatial parameters that characterize a desired state of the robotic system. The commands may be generated by higher-level planning systems, user inputs, or autonomous decision-making processes of the robotic system, as described previously with reference to FIG. 6.

Process 1100 proceeds to act 1104, where the computer processor receives component data for the robotic system. The component data may include information about the physical characteristics, operational state, and configuration of components of the robotic system. The component data may include parameters such as motor winding resistance, torque constants, driver efficiency values, and bus voltage levels for actuators of the robotic system, as described herein. The component data may also include current position readings from encoders, velocity measurements, temperature readings from temperature sensors, and current measurements from current sensors associated with the actuators. The component data provides information that characterizes the state of the robotic system and the properties of the components that will execute the control signals.

Process 1100 continues to act 1106, where the computer processor estimates operating conditions for the robotic system. The operating conditions may include estimated current draw, estimated temperature, estimated power consumption, or other operational parameters associated with the actuators of the robotic system. The estimation of operating conditions may be based on the commands received at the step 1102 and the component data received at the step 1104. By estimating operating conditions before executing control signals, the method 1100 allows the robotic system to anticipate whether the control signals would cause operating conditions to exceed safe operating limits.

Process 1100 proceeds to act 1108, where the computer processor processes the estimated operating conditions and the commands using a trained machine learning model to generate control signals that comply with safe operating limits. The trained machine learning model may receive the estimated operating conditions and the commands as inputs and may generate control signals as outputs. The trained machine learning model may be trained to generate control signals that achieve the target pose specified by the commands while respecting constraints defined by the safe operating limits. The safe operating limits may include maximum operating temperatures, maximum operating currents, power consumption thresholds, or other operational parameters that define acceptable operating ranges for the actuators.

The trained machine learning model may learn behaviors that consider the operating conditions when generating control signals. By providing the estimated operating conditions as inputs to the trained machine learning model, the method 1100 enables the trained machine learning model to condition the generated control signals on the current and predicted operating state of the robotic system. The trained machine learning model may generate control signals that distribute load across actuators, adjust movement trajectories, or modify timing of movements to achieve the target pose without exceeding the safe operating limits. The integration of operating condition estimation with the trained machine learning model allows the robotic system to generate control signals that are both effective for achieving target poses and compliant with constraints that protect the robotic system from damage.

Estimating the operating conditions for the robotic system, as described previously with reference to FIG. 11, may comprise estimating the current of a plurality of actuators. The robotic system may incorporate electrical current consumption information into a learned motor control policy to encourage current-efficient behaviors while respecting hardware constraints. The actuators of the robotic system draw electrical current from a battery through a power distribution board, which provides current limiting guardrails to prevent excessive power draw that could cause the robotic system to shut down. The actuators may be organized into discrete electrical buses that are limited to a finite current-carrying capacity, as described previously with reference to FIG. 3.

Estimating the current of the plurality of actuators may comprise estimating a current draw for respective actuators of the plurality of actuators based on an angular velocity, applied torque, resistance, torque constant, and efficiency of the respective actuator. The current drawn from a particular actuator depends on the torque, velocity, and the mechanical and electrical constraints of the actuator and the robotic system. The current draw for a respective actuator may be calculated using the formula:

$$I = \frac{ω \cdot τ + R \cdot {( \frac{τ}{{K}_{t}} )}^{2}}{η \cdot {V}_{bus}}$$

where I is the computed current draw, ω is the angular velocity, τ is the applied torque, R is the motor winding resistance, Kₜ is the motor torque constant, η is the driver efficiency, and V_{bus} is the voltage of the system.

The torque and velocity values may be calculated from the motor control policy based on the commands and target pose. The motor winding resistance may be manually measured for each actuator type. The torque constant may be determined experimentally from data collected during operation of the actuators. The driver efficiency may be estimated to be 90% for current draw calculations. The bus voltage may be assumed to be a nominal voltage based on the battery in the robotic system.

The robotic system may validate the measured and experimental parameters used in the current estimation formula. Model validation may involve comparing the current draw calculated using the formula against measured values from current sensors on individual actuators. The validation may also involve comparing aggregated calculations along a kinematic chain against measured values to validate the current estimation across the robotic system. The measured and experimental parameters, including the winding resistance and torque constant, may be hand tuned until the error between calculated and measured current values is under 10%.

The method may further comprise calculating a total current estimate for a subset of the plurality of actuators that share a common electrical bus. With the validated parameters, the robotic system may estimate actuator and bus current draws in simulation based on the torque and velocity of each joint. The total current estimate for actuators sharing a common electrical bus may be calculated by summing the individual current estimates for each actuator connected to that bus. The total current estimate allows the robotic system to determine whether the combined current draw of actuators on a bus would exceed the current-carrying capacity of that bus.

The robotic system may penalize the motor control policy in simulation for exceeding the per-bus current limits. During training of the motor control policy, the simulation environment may apply penalties when the total current estimate for a bus exceeds the per-bus limit. The penalties may encourage the motor control policy to learn behaviors that distribute current draw across actuators and buses in a manner that respects the current budgets of the electrical buses.

The robotic system may provide per-bus and whole body current values as input observations to the motor control policy. By providing the current values as inputs, the motor control policy may condition the output control signals on the current consumption state of the robotic system. The motor control policy may adjust the generated control signals based on the observed current values to avoid exceeding per-bus limits or to reduce current draw when approaching capacity limits.

The current observation may have a configurable temporal delay between action execution and current observation. The temporal delay may model the causal relationship between motor commands and resulting current draw. Accordingly, when the motor control policy executes an action, the resulting current draw may not be immediately observable due to the dynamics of the electrical and mechanical systems. The configurable temporal delay allows the motor control policy to learn the relationship between actions and their delayed effects on current consumption, enabling the motor control policy to anticipate current draw and generate control signals that comply with safe operating limits.

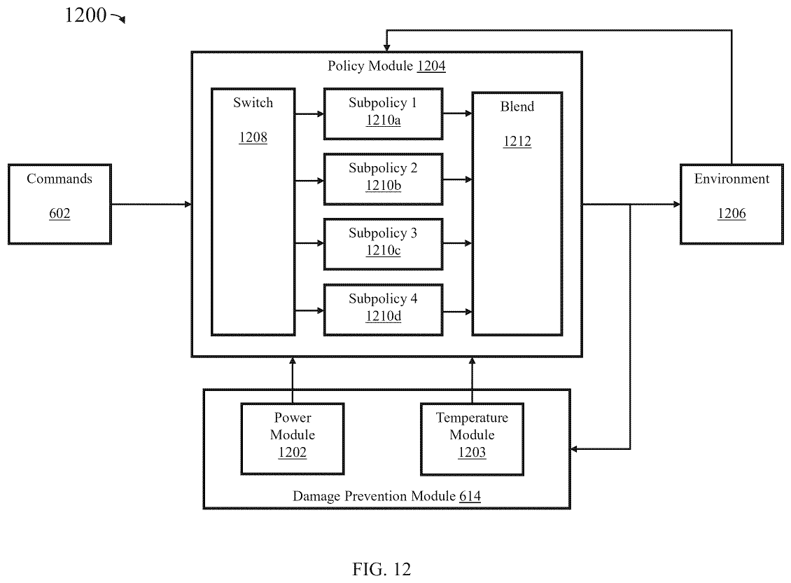

FIG. 12 illustrates a system 1200 for motor control with integrated thermal and power monitoring, in accordance with some embodiments of the technology described herein. The system 1200 incorporates thermal modeling into the control pipeline through thermal parameter characterization, model validation, and thermal feedback integration. The system 1200 includes the commands 602, the damage prevention module 614, and environment observations 1206 obtained through sensors of the robotic system. The machine learning model of FIG. 12 includes a transformer architecture that includes a switch layer 1208, a plurality of subpolicies (e.g., a mixture of experts), and a blend layer 1212.

The commands 602 are received as input to the system 1200 and are directed to the policy module. The switch 1208 receives the commands 602 and routes the commands 602 to one or more of the trained subpolicies. The subpolicies include a first subpolicy 1210a, a second subpolicy 1210b, a third subpolicy 1210c, and a fourth subpolicy 1210d. Each subpolicy receives input from the switch layer 1208 and generates respective outputs. The outputs from the subpolicies are provided to the blend layer 1212, which combines the outputs from the subpolicies to generate control signals that are sent to the environment 1206.

Damage prevention module 614 includes a power module 1202 and a temperature module 1204. The power module 1202 provides power estimates as input to the policy module 1204. The temperature module 1203 provides temperature estimates input to the policy module 1204. The temperature module 1203 also receives feedback on the environment 1206 around the robotic system from sensors such as the vision subsystem.

The damage prevention module may be used during training of the policy module and/or during implementation of the policy module to provide inputs on the power consumption and/or the temperature of components as inputs to the policy module for use in determining control signals for the robotic system.

During training based on the power consumption, the per-bus and whole body current values from power module 1202 are provided as input observations to the motor control policy, allowing the policy to train its output on current consumption state. The current values may be configured with a temporal delay between action execution and current observation to model the causal relationship between motor commands and resulting current draw.

During training based on the temperature of components, the temperature estimates from temperature module 1203 are fed as inputs to the policy module, enabling the policy to learn behaviors that mitigate temperature rise in high effort positions and reduce thermal stress on actuators approaching maximum operating temperatures.

During implementations of the policy module, the power consumption and/or temperature of components may be provided to the policy module as real-time or near real-time feedback on the impact of the generated control signals on the power consumption and temperature of components, allowing the policy module to respond to the safe operating limits in real time.

The thermal modeling by power module 1202 may be implemented using the techniques described above in connection with FIG. 11. The temperature modeling by temperature module 1203 may model the heating to actuators during use. Motors heat up proportionally to how hard the motors are working due to copper losses. Copper losses represent energy dissipated in the motor windings. The copper losses are modeled by the formula:

$$P = {I}^{2} R$$

where P is the power loss, I is the phase current, and R is the resistance across the windings. The power loss due to copper losses causes thermal energy to accumulate in the actuators during operation. Different motors have different thermal properties, and the robotic system may experimentally characterize the thermal parameters of each motor type through thermal parameter characterization.

Thermal parameter characterization involves applying a known low amount of torque to a stalled actuator and collecting torque and temperature readings over an extended period. In some embodiments, the extended period may be one to two hours. By applying a test torque to a stalled actuator, the robotic system may observe the thermal response of the actuator without the confounding effects of mechanical movement.

The temperature and time data collected during thermal parameter characterization are fit using a first-order response model with nonlinear least-squares regression. From the fit, the robotic system calculates two parameters: thermal resistance and thermal capacitance. Thermal resistance represents how the motor dissipates heat to the surrounding environment. Thermal capacitance represents how much heat the motor can store before reaching elevated temperatures. The thermal resistance and thermal capacitance parameters characterize the thermal behavior of each actuator type.

Estimating the temperature of the plurality of actuators may comprise estimating a change in temperature for each of actuator based on a heating coefficient and a cooling coefficient for the respective actuator. Using the characterized thermal resistance and thermal capacitance values as initial estimates, the robotic system determines heating and cooling coefficients. The heating coefficient captures the temperature rise from copper losses during operation. The cooling coefficient reflects heat dissipation to the ambient environment.

The heating coefficient and the cooling coefficient for a respective actuator may be estimated by applying a test torque to a stalled actuator, collecting torque and temperature readings over a plurality of test torque applications, and estimating the heating coefficient and the cooling coefficient from change in the torque and temperature readings in response to the test torque applications. The heating and cooling coefficients may be optimized using covariance matrix adaptation evolutionary strategy by comparing model predictions against real runtime data. The optimization process adjusts the coefficients until the model predictions match the observed thermal behavior during actual operation of the robotic system.

Motors of the same type may have different coefficients because placement of the motors within the robotic system affects how the motors are heated and cooled by surrounding motors. An actuator positioned adjacent to other high-load actuators may experience different thermal conditions than an actuator positioned in an isolated location. Because the robotic system may be symmetrical, symmetrical joints such as left and right knee joints may be constrained to share the same heating and cooling coefficients. The constraint on symmetrical joints reduces the number of independent parameters while accounting for the similar thermal environments experienced by corresponding joints on opposite sides of the robotic system.

With the experimentally determined heating and cooling parameters, the temperature module 1203 may estimate motor temperatures in simulation based on the torque applied to each joint. In some embodiments, the temperature dynamics are modeled by:

$$\frac{dT}{dt} = β \cdot τ - α ( T - {T}_{ambient} )$$

where α is the cooling coefficient, B is the heating coefficient, τ is the applied torque, T is the motor temperature, and T_{ambient} is the outside temperature. The formulation accounts for temperature rises with applied torque through the heating term and falls as the motor dissipates heat to the environment through the cooling term.

The temperature estimates generated by the temperature module 1204 are fed as inputs to the walking policies. By providing temperature estimates as inputs, the robotic system enables the walking policies to adjust behaviors to mitigate temperature rise in high effort positions. High effort positions may include positions such as squatting where actuators experience sustained loads. The walking policies may modify movement trajectories, adjust timing of movements, or transition between subpolicies to reduce thermal stress on actuators that are approaching maximum operating temperatures. The integration of the temperature module 1203 with the policy module through the blend 1212 allows the system 1200 to generate control signals that achieve target poses while respecting power and/or thermal constraints of the actuators.

Although FIG. 12 illustrates an implementation of policy module 1204 for generating control signals for the robotic system, a similar configuration may be used to train.

### V. Working Examples

### V(I). Method

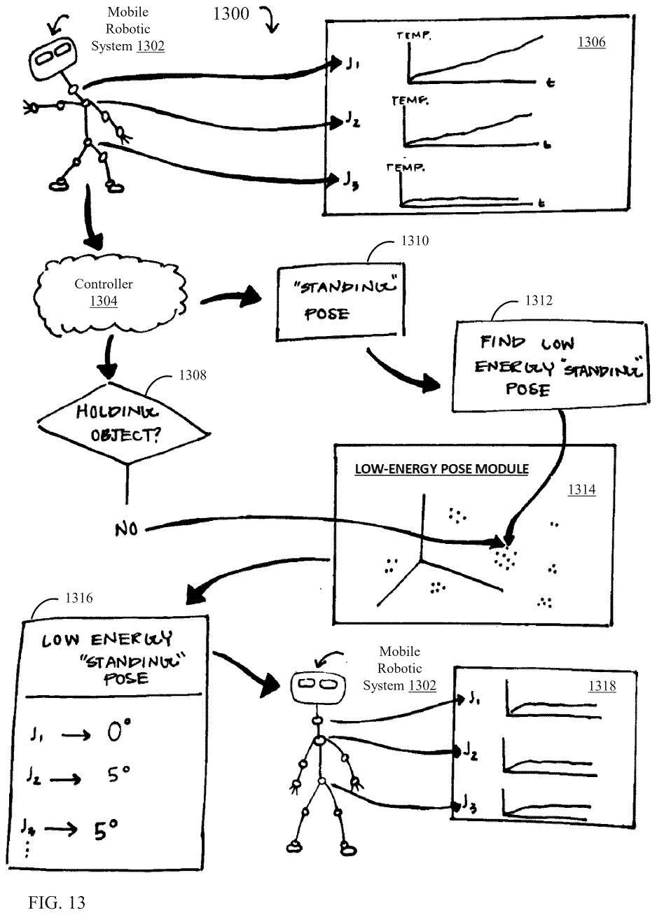

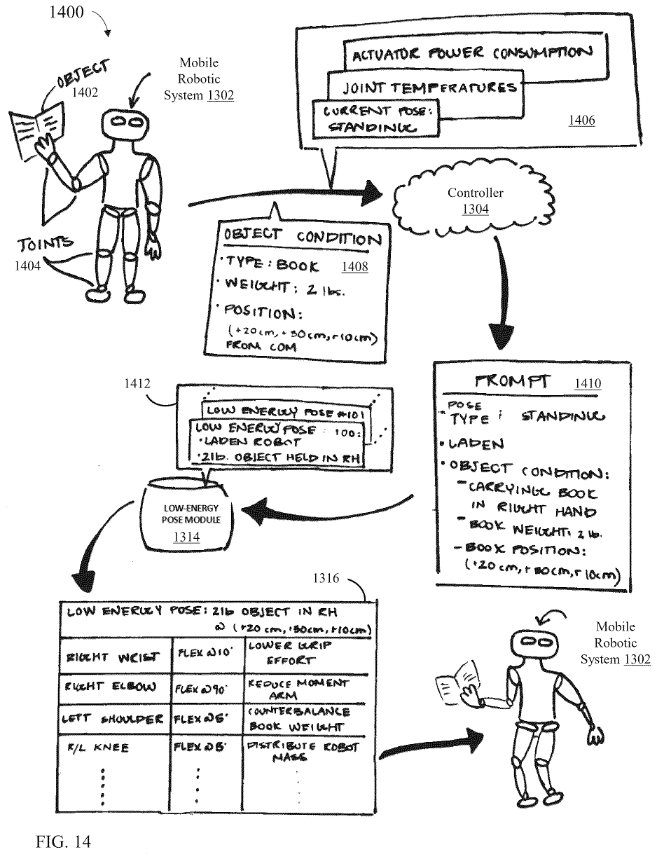

As shown in FIGS. 13 and 14, methods 1300 and 1400 include, at a controller 1304 arranged within a mobile robotic system 1302: selecting a target static pose type 1310 (e.g., standing) for the mobile robotic system; and accessing a current pose of the mobile robotic system, the current pose defining a current joint position for each joint in a set of joints 1404 within the mobile robotic system. The robotic system may monitor and/or estimate a temperature or strain associated with the operating conditions of the robotic system in the current pose. The robotic system may also estimate a rate of temperature change or strain accumulation to determine how maintaining the present pose will impact the temperature or strain on actuators of the robotic system. The temporal evolution of temperature for each joint 1306 of the robotic system 1302 may be stored or monitored, as shown in FIG. 13.

Method 1300 may include a determination of whether the robotic system 1302 is holding an object 1308 or otherwise bearing an increased load. Upon receiving a request or task to maintain or transition to a pose, such as a standing pose 1310, the robotic system may evaluate multiple standing configurations that involve different positions for the robotic system within the parameters for the standing pose. The different positions may be evaluated by a low energy pose module 1314 for the energy required and/or temperature or strain produced at the actuators of the robotic system to determine an optimized configuration for executing the requested pose. In this way, the robotic system 1302 may determine a low energy pose 1316 that accounts for the current temperature, strain, or power conditions of the robotic system in determining control signals for the execution of the requested pose. The resulting temperature at each joint of the robotic system may thus reduce overall wear or strain upon the robotic system as shown in 1318.

The method 1400 includes, at the controller 1304, accessing a load condition of the mobile robotic system, the load condition representing: characteristics (e.g., a weight) of an object 1402 carried by the mobile robotic system; and a relative object position of the object relative to a reference position on (e.g., a center of mass of) the mobile robotic system.

The method 1400 further includes, at the controller, querying a low-energy pose module 1314 for a target low-energy pose 1316 based on the target static pose type and the load condition, the target low-energy pose 1316 defining target positions of the set of joints within the mobile robotic system predicted to yield a minimum total energy consumption per unit time by the mobile robotic system (or minimum peak motor temperature in any joint, etc.) during execution of the target low-energy pose by the mobile robotic system while carrying the object at the relative object position. In the illustrated example of FIG. 14, robotic system 1302 may detect a current object condition 1408 that includes the type of object 1402 held by the system, a weight of the object, a position of the object, and any other contextual information determined by the system. For the example of a book, the contextual information may include the title of the book, the author, the genre, any comment the robotic system has received from a user about the book, and/or any trends the robotic system has detected regarding how users interact with the object. The controller 1304 of the robotic system 1302 may use the object condition 1408 operational parameters 1406 and a prompt 1410 to determine a pose which will then be sent to lower energy pose module 1314 for optimizing a configuration of the robotic system with which to execute the pose 1316 while adhering to safe operational limits and/or improving efficiency. In some embodiments, the operational parameters 1406 may include a current pose of the joints of the robotic system, joint temperatures of the robotic system, and power consumption by actuators of the robotic system.

The low-energy pose module 1314 is configured to return low-energy poses: representing positions of the set of joints within the mobile robotic system predicted to yield minimum total energy consumption per unit time by the mobile robotic system (or minimum peak motor temperatures in any joint, etc.) during execution of target low-energy poses by the mobile robotic system while carrying objects of various masses at various relative object positions.

The methods 1300 and 1400 further include, at the controller 1304, driving each actuator, in the set of actuators within the mobile robotic system, to a corresponding target joint position defined in the target low-energy pose.

### V(II). Applications

Generally, the method 1300 can be executed by a mobile robotic system 1302: to select a target pose (e.g., sitting, standing, leaning) currently occupied by or in the process of being occupied by the mobile robotic system; to access state information (e.g., current joint positions) of the mobile robotic system; to track or derive characteristics of an object carried by the mobile robotic system, such as a relative position of the object, a mass of the object, a center of gravity of the object, and/or a combined center of gravity of the object and the mobile robotic system; and to inject the state information and object characteristics into a low-energy pose module 1314 configured to transform state information and object characteristics into low-energy poses 1316.

In particular, the low-energy pose module 1314 returns a target low-energy pose: specifying target joint positions of each (or many, some) joint within the mobile robotic system; and executable by joints in the mobile robotic system to limit total energy consumption by the entire mobile robotic system, to limit total energy consumption by specific joints within the mobile robotic system, and/or to limit temperature rise in all or specific joints in the mobile robotic system while the mobile robotic system occupies the target pose while carrying the object in the relative object position. The controller then triggers the actuators within the mobile robotic system to drive these joints to their corresponding target joint positions according to the target low-energy pose returned by the low-energy pose module.

For example, the controller 1304 can execute (or interface with) a low-energy pose module 1314 in the form of: a neural network that ingests state information and object characteristics and returns a target low-energy pose; an n-dimensional vector space populated with simulated or empirical combinations of state information, object characteristics, and low-energy poses and that implements nearest neighboring or clustering techniques to return a target low-energy pose; an algebraic function that ingests state information and object characteristics and returns a target low-energy pose; or a lookup table that ingests state information and object characteristics and returns a nearest predefined target low-energy pose.

The mobile robotic system 1302 can thus execute a target low-energy pose—returned by the low-energy pose module—in order to limit total energy consumption by some or all joints in the mobile robotic system, extend battery life of the mobile robotic system, limit peak temperature of all motors (or specific motors) in the mobile robotic system, and/or reduce risk of heat-related damage to joints in the mobile robotic system while occupying (or “maintaining”) a target pose. The mobile robotic system can also repeat this process to calculate a new target low-energy pose responsive to a change in object characteristics of an object carried by the mobile robotic system (e.g., a user loads or unloads an object from the mobile robotic system).

In addition to executing a low-energy pose, the mobile robotic system can continuously refine control strategies to maintain energy efficiency across different operating conditions. In particular, the system can assume a low-energy pose (e.g., a static configuration of joint positions or a low-energy policy) to minimize total energy consumption. Additionally or alternatively, the mobile robotic system may encounter dynamic inputs that require active adjustments to maintain efficiency. For example, in response to external forces (e.g., shifting object loads, changing wind conditions, or tension from holding a dog leash), the system can implement a low-energy transition by modifying joint torques and actuator outputs to prevent unnecessary energy expenditure while stabilizing the target low-energy pose. Furthermore, when the mobile robotic system executes a continuous motion, such as walking or climbing stairs, the mobile robotic system can derive and execute a sequence of low-energy intermediate poses to maintain energy-efficient movements across multiple sequential joint adjustments. In some embodiments, these movements may be generated by a policy that is configured to produce controls that are compliant with energy or temperature safe operation limits. Thus, the mobile robotic system can adapt to dynamic environments and task-specific constraints while maintaining efficient power consumption.

### V(III). Mobile Robotic System

Generally, the mobile robotic system 1302 is configured for deployment within a space (e.g., a home or other human centric environment) to autonomously execute tasks responsive to a command and/or a query (e.g., “Find my wallet.”) from a user. In particular, the mobile robotic system includes: a set of body segments (e.g., a torso, a set of legs), each body segment mechanically coupled to an adjacent body segment via a joint; and a set of actuators arranged at the joints and configured to enable controlled movement of the body segment(s), as further discussed in FIGS. 2 and 3 above. The mobile robotic system can maintain a target low-energy pose to reduce power consumption by the actuators when the mobile robotic system is in a static position (e.g., standing idle), thereby preventing the actuators from overheating. For example, the mobile robotic system can maintain a target low-energy pose that biases torque distribution, such as to balance load across the actuators, prioritize energy efficiency, and/or limit peak temperature in high-power actuators.

In particular, the mobile robotic system can query the low-energy pose module for a target low-energy pose based on: state information of the mobile robotic system, such as an ongoing task status and/or conditions (e.g., temperatures, current draws) of the set of actuators; and object characteristics (e.g., weights, object types) and a relative object position of an object currently carried by the mobile robotic system. The mobile robotic system can then implement the target low-energy pose to yield a minimum total energy consumption per unit time by the mobile robotic system (or minimum peak motor temperature in any joint, etc.).

### V(IV). Low-Energy Motions

The mobile robotic system 1302 can also: implement similar methods and techniques to calculate a sequence of target low-energy poses that together represent an action or motion (e.g., a walking stride, lifting an object); and execute this sequence of target low-energy poses in series in order to limit total energy consumption by some or all joints in the mobile robotic system, extend battery life of the mobile robotic system, limit peak temperature of all motors (or specific motors) in the mobile robotic system, and/or reduce risk of heat-related damage to joints in the mobile robotic system while performing this action or motion.

Accordingly, the mobile robotic system can implement low-energy poses (e.g., static poses) and low-energy motions that reduce overall power consumption by the actuators, minimize peak temperatures, and/or balance load across actuators when the mobile robotic system is idling or executing tasks. Therefore, the mobile robotic system can: reduce total power consumption by maintaining low-energy poses while idle and executing low-energy motions during task transitions; prevent actuator overheating by limiting sustained high-torque output and strategically distributing mechanical load; and increase actuator lifespan by reducing continuous strain and excessive power draw during both static and dynamic operations.

### V(V). Low-Energy Pose Module+Low-Energy Motion Module

Furthermore, the methods 1300 and 1400 described herein as executed by the mobile robotic system 1302 that stores a low-energy pose module (e.g., a local instance of a low-energy pose module) 1314 in local memory and queries this local low-energy pose module for low-energy poses for execution by the mobile robotic system. In one example, the mobile robotic system can load and implement a neural network- or other artificial intelligence model configured to: ingest state information 1306 of the mobile robotic system (e.g., a current static pose type, a weight of an object carried by the mobile robotic system, or temperatures associated with the actuators of the robotic system); and return a target low-energy pose (e.g., configured to yield a minimum power consumption across the set of actuators).

Additionally or alternatively, the mobile robotic system can execute Blocks of the methods 1300 and 1400: to query a remote low-energy pose module executed remotely (e.g., on a remote computer network or remote server) for low-energy poses; and to handle responses returned by the remote low-energy pose module.

### V(VI). Mobile Robotic System

Generally, the mobile robotic system is configured to navigate through a space (e.g., a home) occupied by the mobile robotic system to execute tasks responsive to a command and/or a query (e.g., “Find my wallet.”) from a user.

The mobile robotic system includes: a set of body segments (e.g., a torso, a set of legs), each body segment mechanically coupled to an adjacent body segment via a joint; and a set of actuators arranged at the joints and configured to enable controlled movement of the set of body segments. In particular, each joint includes: an actuator configured to enable controlled movement of the body segment(s) coupled via the joint; and a set of (e.g., one or more) sensors configured to output signals representing conditions at the joint, as further discussed in connection with FIGS. 2 and 3 above. For example, each set of sensors can include: a torque sensor configured to output signals representing the applied torque by the actuator arranged at the joint; a temperature sensor configured to output signals representing a temperature of the actuator; a current sensor configured to output signals representing electrical power consumption (e.g., current draw and voltage input) at the actuator; and/or a load sensor configured to output signals representing a force exerted on the joint (e.g., a weight of an object carried by the mobile robotic system).

The mobile robotic system can further include: a set of (e.g., one or more) optical sensors configured to generate images representing visual characteristics (e.g., color, texture, patterns, visual markers) of surfaces proximal the mobile robotic system; and/or a set of (e.g., one or more) depth sensors (e.g., RADAR sensors, LIDAR sensors, structured light sensors) configured to generate depth maps representing spatial geometry of surfaces proximal the mobile robotic system.

The mobile robotic system can further include a controller configured to: interpret signals output by the set of sensors at each joint; interpret images and/or depth maps output by the optical and/or depth sensors; and output commands to the set of actuators based on these signals, images, and/or depth maps.

### V(VII). Low-Energy Pose

In one implementation, the mobile robotic system can maintain a target low-energy pose (e.g., a static posture) that minimizes energy consumption and peak temperatures across the set of actuators. In some embodiments, a target low-energy pose may define a target joint position for each joint in the mobile robotic system. More specifically, at each joint, the actuator is configured to locate the joint according to the target joint position (e.g., a particular angular configuration) to locate the body segment(s), coupled via the joint, in a particular configuration.

The mobile robotic system can maintain a target low-energy pose to: reduce joint load by limiting torque at joints (e.g., hips, knees, shoulders), such as by aligning body parts with gravity-assisted resting positions; increase passive support with minimal actuator engagement or activation; and/or minimize heat generation by lowering power consumptions (e.g., electrical current draw), such as by deactivating or idling actuators in body segments that are irrelevant to a particular pose (e.g., arms in a static standing pose).

In one implementation, the mobile robotic system can maintain a target low-energy pose that minimizes a total (e.g., combined) power consumption across the set of actuators or across a subset of actuators associated with a kinematic chain. Alternatively, the mobile robotic system can maintain a target low-energy pose that biases torque distribution, such as to balance load across actuators, prioritize energy efficiency, and/or limit peak temperatures in high-power actuators.

V(VII)(a). Low-Energy Pose with Uniform Nominal Torque Bias

In one variation, the mobile robotic system can maintain a target low-energy pose that limits excessive load on any single actuator. In this variation, the mobile robotic system can: define a maximum torque output (e.g., 5% of peak torque output) for each actuator in the set of actuators; and implement a target low-energy pose that maintains each actuator in the set of actuators below the maximum torque output defined for the actuator. Thus, the mobile robotic system can distribute torque output across the set of actuators such that each actuator operates at a low percentage of the peak torque output of the actuator, rather than concentrating high torque demand on a single actuator while others remain inactive.

V(VII)(b). Low-Energy Pose with Motor Hierarchy

In one variation, the mobile robotic system can maintain a target low-energy pose that minimizes power consumption by high-load actuators, such as actuators configured to: support the weight of the mobile robotic system (e.g., hip actuators, knee actuators); stabilize the mobile robotic system (e.g., ankle actuators); and/or execute load-bearing tasks (e.g., arm actuators).

In one example, the mobile robotic system can: define a first maximum torque output (e.g., 25% of peak torque output) for each actuator in a first subset of low-load actuators (e.g., finger actuators) in the set of actuators; define a second maximum torque output (e.g., 10% of peak torque output), different from the first maximum torque output, for each actuator in a second subset of high-load actuators (e.g., hip actuators) in the set of actuators; and implement a target low-energy pose that maintains each actuator in the first subset of low-load actuators below the first maximum torque output and each actuator in the second subset of high-load actuators below the second maximum torque output. Thus, the mobile robotic system can strategically distribute torque output across the set of actuators, such as based on the mechanical load and/or the functionality of each actuator.

V(VII)(c). Low-Energy Pose with Temperature Bias

In one variation, the mobile robotic system 1302 can maintain a target low-energy pose that mitigates thermal accumulation in the actuators by distributing mechanical load and modulating torque output in response to actuator temperature conditions. In this variation, the mobile robotic system can: define a temperature threshold for each actuator in the set of actuators; and implement a target low-energy pose that maintains each actuator in the set of actuators below the temperature threshold defined for the actuator. Thus, the mobile robotic system can strategically distribute torque output across the set of actuators to prevent thermal overloading and increase longevity of the actuators.

### V(VIII). Low-Energy Pose Derivation: Standing

Generally, a computer system may be used to virtually simulate and/or empirically derive low-energy poses for execution by the mobile robotic system by estimating (or measuring) actuator power consumption across different standing configurations. In some embodiments, the computer system may be a processor and associated components that are integrated within the robotic system 1302. In some embodiments, the computer system may be a processor and associated components that are separate from the robotic system 1302.

As a example, the computer system can estimate (or measure) actuator power consumption over a range of: standing poses, each standing pose defining a unique set of joint positions; and load conditions. In particular, a load condition can represent: characteristics and/or relative positions of an external object (e.g., a water bottle) carried by the mobile robotic system; and/or characteristics (e.g., frequency, magnitude, direction) and/or relative positions of an external force acting on the mobile robotic system, such as a wind force, or a pushing force imparted on the mobile robotic system by a user. Furthermore, the computer system can derive a particular low-energy pose based on a specific bias (e.g., uniform torque distribution, motor hierarchy considerations, or thermal constraints), as described above.

### V(VIII)(a). Simulation: Unladen Robotic System

In one implementation, the computer system can: virtually simulate an unladen (e.g., nominal) robotic system over a range of virtual standing poses; and derive an estimated power consumption (e.g., modeled current draw, back electromotive force, and actuator efficiency) by each virtual actuator of the unladen robotic system in each virtual pose, using the methods described herein. In particular, the computer system may estimated power consumption at a particular actuator based on a simulated torque demand, angular velocity, voltage input, and/or actuator characteristics (e.g., efficiency, friction and damping coefficients, and rotor inertia).

In this implementation, the computer system can: initialize a virtual, unladen robotic system in a virtual field; define a first virtual standing pose defining a first virtual joint position for each virtual actuator; trigger the set of virtual actuators to locate the virtual joints according to the first virtual standing pose; and derive a first estimated power consumption of each virtual actuator with the virtual, unladen robotic system in the first virtual standing pose.

The computer system can then: define a second virtual standing pose by perturbing the first virtual joint position of each virtual actuator, the second virtual standing pose defining a second virtual joint position for each virtual actuator; trigger the set of virtual actuators to locate the virtual joints according to the second virtual standing pose; and derive a second estimated power consumption of each virtual actuator with the virtual, unladen robotic system in the second virtual standing pose.

At a particular virtual actuator, in response to the second estimated power consumption improving (e.g., decreasing) from the first estimated power consumption (e.g., based on a bias as described above), the computer system can: define a third virtual joint position by perturbing the second virtual joint position in a similar direction as the adjustment from the first to the second virtual joint position; and implement methods and techniques described above to derive a third estimated power consumption by the virtual actuator.

Alternatively, at a particular virtual actuator, in response to the second estimated power consumption worsening (e.g., increasing) from the first estimated power consumption (e.g., based on a bias as described above), the computer system can: define a fourth virtual joint position by perturbing the second virtual joint position in a different direction as the adjustment from the first to the second virtual joint position; and implement methods and techniques described above to derive a fourth estimated power consumption by the virtual actuator.

The computer system can then iteratively repeat this process to converge on a target low-energy (e.g., lowest energy) virtual standing pose (e.g., based on a bias as described above) for the virtual, unladen robotic system. By simulating the virtual, unladen robotic system over a range of virtual poses, the computer system can rapidly converge on a target low-energy virtual standing pose for the virtual, unladen robotic system. The mobile robotic system can then implement a target low-energy standing pose (e.g., corresponding to the target low-energy virtual standing pose) to reduce power consumption and peak temperatures in the actuators in real-world operation.

### V(VIII)(b). Simulation: Laden Robotic System

In another implementation, the computer system can: virtually simulate a laden robotic system (e.g., carrying a payload or holding an external object) over a range of virtual standing poses and load conditions; and implement methods and techniques described above to converge on a lowest-energy virtual standing pose for the virtual, laden robotic system.

In one implementation, the computer system can virtually simulate the laden robotic system over a range of virtual standing poses with the laden robotic system carrying various objects. In particular, the computer system can virtually simulate the laden robotic system carrying various objects: exhibiting different object characteristics (e.g., object types, object sizes, object shapes, object weights); and carried by the laden robotic system in different relative positions. For example, the computer system can converge on a particular low-energy virtual standing pose when the laden robotic system is carrying a water bottle in a right hand of the laden robotic system.

In another implementation, the computer system can virtually simulate the laden robotic system over a range of virtual standing poses with the laden robotic system encountering various external forces. In particular, the computer system can virtually simulate the laden robotic system encountering various external forces: exhibiting different characteristics (e.g., frequencies, force magnitudes, force directions); and imparted on the laden robotic system in different relative positions. For example, the computer system can converge on a first low-energy virtual standing pose when the laden robotic system encounters a wind force distributed across an entire surface area of the laden robotic system. Alternatively, the computer system can converge on a second low-energy virtual standing pose, different from the first low-energy virtual standing pose, when the laden robotic system encounters a localized pushing force (e.g., imparted by a user) applied at a particular relative position (e.g., a force exerted on the shoulder or arm) on the laden robotic system.

In this implementation, the computer system can initialize a virtual, laden robotic system in a virtual field with a first virtual object of a first weight carried in a first virtual relative object position (e.g., relative to a center of mass of the virtual, laden robotic system). The computer system can then implement methods and techniques described above to converge on a target low-energy virtual standing pose for the virtual, laden robotic system carrying the first virtual object of the first weight in the first virtual relative object position. Furthermore, the computer system can implement methods and techniques described above to converge on a population of low-energy virtual standing poses with the virtual, laden robotic system carrying various virtual objects of different weights and/or in different virtual relative object positions.

### V(VIII)(c). Empirical Derivation

In one implementation, the mobile robotic system can execute empirical calibration cycles to test power consumption (e.g., current draw, back electromotive force) at each joint while the mobile robotic system is operating within the space. For example, the mobile robotic system can execute an empirical calibration cycle when: the mobile robotic system is in an idle state (e.g., the mobile robotic system is not actively responding to a user query and/or fulfilling a user command); and/or an available battery power exceeds a threshold battery power (e.g., 80%).

In this implementation, during an empirical calibration cycle, the controller can: trigger the set of actuators to locate the joints according to a particular pose; access signals output by the set of sensors (e.g., torque sensors, temperature sensors) at each actuator with the mobile robotic system in this pose; and derive a power consumption of each actuator based on these signals (e.g., based on measured current draw, back EMF, torque demand, and actuator efficiency). In particular, the controller can: define a first standing pose defining a first joint position for each joint; trigger the set of actuators to locate the joints according to the first standing pose; and derive a first power consumption of each actuator with the unladen mobile robotic system in the first standing pose. The controller can then, implement methods and techniques described above to converge on a target low-energy standing pose (e.g., based on a bias as described above) for the unladen mobile robotic system. Therefore, the mobile robotic system can autonomously execute empirical calibration cycles while operating within the space to refine these low-energy poses.

### V(IX). Data Aggregation and Low-Energy Module Construction

Generally, the computer system and or robotic system can compile a population of low-energy poses (e.g., simulated and/or empirically-derived), each low-energy pose may be paired with a load condition, into a low-energy pose module. In particular, the low-energy pose module can: ingest a load condition of the mobile robotic system; and output a target low-energy pose configured to yield a target power consumption (e.g., based on a bias as described above) based on the load condition.

In one implementation, the computer system can implement a neural network (e.g., a conditional generative adversarial network) to train the low-energy pose module. In particular, in this implementation, the computer system can: load the low-energy pose module onto an instance of the mobile robotic system; receive a query from the mobile robotic system for a target low-energy pose based on a load condition of the mobile robotic system; and return a target low-energy pose to the mobile robotic system based on the load condition.

In another implementation, the computer system can: store each low-energy pose and a corresponding load condition in a vector; represent a population of vectors in an n-dimensional space; store the n-dimensional space populated with the population of vectors as a low-energy pose module; and load the low-energy pose module onto an instance of the mobile robotic system. Then, the mobile robotic system can: project a current load condition into the low-energy pose module (e.g., into the n-dimensional space); implement clustering or nearest neighbor techniques to identify a group of vectors in the n-dimensional space representing load conditions similar to the current load condition; and interpolate or extrapolate a target low-energy pose from the group of vectors based on the current load condition.

### V(IX)(a). Non-Convergent Data Simulation or Collection

As described above, the computer system and/or the mobile robotic system can implement closed-loop controls to converge on a target low-energy pose (e.g., based on a bias as described above). Alternatively, the computer system and/or the mobile robotic system can (pseudo) randomly define a population of unique poses that constitute or fulfill a defined “standing” configuration. The computer system (or the mobile robotic system) can then implement methods and techniques described above to: trigger the virtual robotic system (or the mobile robotic system) to execute each unique pose; derive an estimated power consumption (or measure a power consumption) with the virtual robotic system (or the mobile robotic system) in each unique pose; and generate a low-energy pose module based on simulated data recorded for the virtual robotic system (or empirical data received from the mobile robotic system).

### V(IX)(b). In-Field Module Development

As described above, a remote computer system can generate a low-energy pose module based on simulated data and/or empirical data received from the mobile robotic system (or from multiple instances of the mobile robotic system). Additionally or alternatively, the mobile robotic system can generate a low-energy pose module based on empirical data collected by the mobile robotic system over time and/or based on local simulations executed by the mobile robotic system, such as to account for unique operating conditions or scenarios encountered by the mobile robotic system during real-world operation.

### V(X). Other Static Pose Types

As described above, the computer system and/or the mobile robotic system can virtually simulate and/or empirically derive a target low-energy standing pose for the laden and unladen mobile robotic system. Additionally or alternatively, the computer system and/or the mobile robotic system can derive low-energy poses with the mobile robotic system in other static pose types, such as sitting, kneeling, and/or leaning.

In one implementation, the computer system can virtually simulate an unladen (e.g., nominal) robotic system over a range of virtual sitting poses. In particular, for each virtual sitting pose, the computer system can access a virtual pose condition representing environmental conditions encountered by the virtual, unladen robotic system. For example, in one configuration with the mobile robotic system seated in a chair, the virtual pose condition can represent: a seat height; a seat angle; presence of a seat back; a seat back height; a seat back angle; presence of chain arms; and/or an arm height.

The computer system can then implement methods and techniques described above to converge on a target low-energy virtual sitting pose for the virtual, unladen robotic system based on estimated power consumptions of the virtual actuators over: the range of virtual sitting poses; and a range of virtual pose conditions.

Additionally or alternatively, the computer system can then implement methods and techniques described above to converge on a target low-energy virtual sitting pose for a virtual, laden robotic system based on estimated power consumptions of the actuators over: the range of virtual sitting poses; a range of virtual pose conditions; and a range of virtual load conditions.

In another implementation, the computer system can implement methods and techniques described above to converge on low-energy kneeling poses by simulating the virtual, unladen robotic system and the virtual, laden robotic system over: a range of virtual kneeling poses; a range of virtual pose conditions; and a range of virtual load conditions.

Additionally or alternatively, the computer system can implement methods and techniques described above to converge on low-energy leaning poses by simulating the virtual, unladen robotic system and the virtual, laden robotic system over: a range of virtual leaning poses; a range of virtual pose conditions (e.g., surface characteristics); and a range of virtual load conditions.

In another implementation, the mobile robotic system can implement methods and techniques described above to empirically derive low-energy poses for execution by the mobile robotic system over: a range of static pose types (e.g., sitting, kneeling, or leaning); a range of pose conditions; and/or a range of load conditions. For example, the computer system can: access an image generated by an optical sensor arranged on the mobile robotic system and representing visual characteristics (e.g., color, texture, patterns, visual markers) of surfaces proximal the mobile robotic system; and detect the pose condition and/or the load condition based on the image.

### V(X)(a). Module Generation

As described above, the computer system can compile a population of low-energy poses into a low-energy pose module. In one implementation, the computer system can compile a population of low-energy poses of each static pose type (e.g., sitting, standing) into a unique low-energy pose module (e.g., a “standing” module, a “sitting” module) corresponding to the static pose type.

Alternatively, the computer system can compile a population of low-energy poses of each static pose type (e.g., sitting, standing) into a single low-energy pose module. For example, the computer system can compile the population of low-energy poses into the low-energy pose module configured to: ingest a current pose (e.g., leaning on a horizontal surface) of the mobile robotic system, a pose condition (e.g., characteristics of the horizontal surface), and a load condition; and output a target low-energy pose based on the current pose, the pose condition, and the load condition. Thus, the low-energy pose module can be trained based on simulated data and/or empirical calibration data. Additionally or alternatively, the low-energy pose module can implement reinforcement learning techniques to derive and/or refine low-energy poses.

### V(XI). Low-Energy Static Pose Execution

In one implementation, the controller can: detect a trigger to transition the mobile robotic system to a low-energy pose; and query the low-energy pose module for a target low-energy pose in response to detecting the trigger. For example, the controller can detect the trigger based on: temperatures of the set of actuators (e.g., exceeding predefined threshold temperatures); a duration of inactivity (e.g., indicating that the mobile robotic system is not actively engaged in a task); and/or a detected reduction in load or external force acting on the mobile robotic system.

The controller can then: select and/or access a target static pose type (e.g., standing) for the mobile robotic system; access a current pose of the mobile robotic system, the current pose defining a current joint position for each joint in a set of joints within the mobile robotic system; access a load condition and/or a pose condition of the mobile robotic system; query the low-energy pose module for a target low-energy pose based on the target static pose type and the load condition; and trigger each actuator in the set of actuators to locate the corresponding joints according to a target joint position defined for the joint in the target low-energy pose. In particular, the controller can trigger each actuator in the set of actuators to navigate the corresponding joint from current joint position to the target joint position. The controller can then iteratively detect triggers to maintain the mobile robotic system in the target low-energy pose, or to transition the mobile robotic system to a new low-energy pose, such as in response to detecting a new load condition.

In one example, the mobile robotic system includes a humanoid domestic assistant deployed in a home. In this example, the mobile robotic system receives a command from a user to “hold the cookbook in place while I make dinner.” In this example, the mobile robotic system: selects the standing pose type; accesses a weight of the cookbook held in a right hand of the mobile robotic system and offset from the center of mass of the mobile robotic system; queries the low-energy pose module for a target low-energy standing pose based on the weight and the relative object position of the cookbook; and triggers the set of actuators to locate the joints according to the target joint positions defined in the target low-energy standing pose. In particular, the target low-energy standing pose defines: a first target joint position for a right elbow joint that locates the cookbook closer to a torso of the mobile robotic system (e.g., to reduce the moment arm and torque demand on the elbow actuator); a second target joint position for a hip joint that slightly shifts the pelvis to the left (e.g., to counterbalance the weight of the cookbook); and a third target joint position for the torso that adjusts the upper body posture to align the center of mass over a base (e.g., a set of legs) of the mobile robotic system.

Furthermore, the mobile robotic system adjusts actuator outputs to maintain a target low-energy pose while limiting energy consumption. Rather than holding a fixed joint configuration, the mobile robotic system modifies motor torque and actuator commands in response to internal and external factors that increase power consumption. For example, in response to external forces such as shifting loads, uneven terrain, or variations in surface friction, the mobile robotic system calculates refined joint positions and adjusts torque distribution to sustain the low-energy pose while reducing unnecessary actuator engagement. Additionally, the mobile robotic system tracks thermal conditions and battery constraints and continuously modifies actuator output to prevent overheating while ensuring stability. By executing real-time control adjustments, the mobile robotic system continuously adapts actuator behavior to sustain a low-energy pose while reducing power consumption across different operating conditions.

### V(XII). Motion+Actions: Low-Energy Pose Sequences

In one implementation, the mobile robotic system can execute low-energy motions that minimize energy consumption and peak temperatures across the actuators while transitioning between poses during execution of a particular task. In particular, the mobile robotic system can execute a target low-energy motion defining a sequence of target low-energy poses for execution by the mobile robotic system. More specifically, at each joint, the actuator is configured to navigate the joint through the sequence of target low-energy poses (e.g., intermediate low-energy poses) during transition from a current pose to a target low-energy pose.

The mobile robotic system can implement methods and techniques described above to execute a target low-energy motion that: minimizes a total (e.g., combined) power consumption across the set of actuators; limits excessive load on any single actuator; minimizes power consumption by high-load actuators; and/or mitigates thermal accumulation in the actuators.

### V(XII)(a). Low-Energy Motion: Simulation+Empirical Derivation

Generally, the computer system can virtually simulate and/or empirically derive target low-energy motions (e.g., sequences of target low-energy poses) for execution by the mobile robotic system by estimating (or measuring) actuator power consumption across different motions. In particular, the computer system can estimate (or measure) actuator power consumption over a range of: walking motions, each walking motion defining a unique sequence of target low-energy poses; motion conditions (e.g., an incline of an uneven surface); and/or load conditions.

Furthermore, the computer system can derive a particular target low-energy motion based on a specific bias (e.g., uniform torque distribution, motor hierarchy considerations, or thermal constraints), as described above. Additionally, the computer system and/or the mobile robotic system can implement methods and techniques described above to converge on target low-energy motions of other motion types (e.g., climbing stairs, sitting down, grasping objects).

The computer system can then implement methods and techniques described above to generate a low-energy motion module configured to: ingest a target motion type, a motion condition, and/or a load condition of the mobile robotic system; and return a target low-energy motion configured to yield a target power consumption (e.g., based on a bias as described above).

### V(XIII). Low-Energy Motion Execution

In one implementation, the mobile robotic system can: select and/or access a target motion type (e.g., walking) for execution by the mobile robotic system; access a current pose of the mobile robotic system, the current pose specifying a current joint position of each joint; access and/or detect a load condition and/or a motion condition of the mobile robotic system; query the low-energy motion module for a target low-energy motion based on the target motion type, the load condition, and/or the motion condition of the mobile robotic system; and trigger each actuator in the set of actuators to navigate the corresponding joint through the sequence of target low-energy poses to locate the joint in a target joint position defined in the target low-energy motion.

In one example, the mobile robotic system includes a humanoid domestic assistant deployed in a home. In this example, the mobile robotic system receives a command from a user to “walk from the living room to the kitchen.” In this example, the mobile robotic system: selects the walking motion type; detects a motion condition including a flooring transition (e.g., via a depth sensor) intersecting a path of the mobile robotic system; queries the low-energy motion module for a target low-energy motion based on the walking motion type and the motion condition; and triggers each actuator to navigate the corresponding joint through the sequence of target low-energy poses defined in the target low-energy walking motion.

### V(XIV). Conclusion

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMS, flash memory, EEPROMs, optical devices (CD or DVD), hard drives, floppy drives, or any suitable device. The computer-executable component can be a processor, but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

### VI. Additional Details

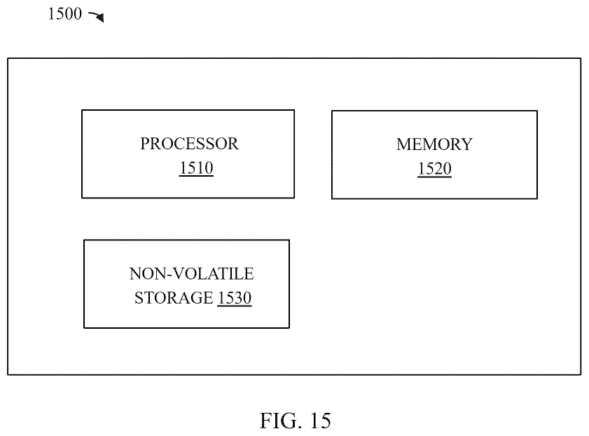

Additionally, FIG. 15 illustrates an illustrative implementation of a special purpose computer system 1500, that may be specially programmed to improve over conventional systems, to be used in connection with any of the embodiments of the disclosure provided herein. The computer system 1500 may include one or more processors 1510 and one or more articles of manufacture that comprise non-transitory computer-readable storage media (e.g., memory 1520 and one or more non-volatile storage media 1530). The processor 1510 may control writing data to and reading data from the memory 1520 and the non-volatile storage device 1530 in any suitable manner. To perform any of the functionality described herein (e.g., secure execution, proxied execution, sandboxed execution, etc.), the processor 1510 may execute one or more processor-executable instructions stored in one or more non-transitory computer-readable storage media (e.g., the memory 1520), which may serve as non-transitory computer-readable storage media storing processor-executable instructions for execution by the processor 1510.

Having thus described several aspects of at least one embodiment of the technology described herein, it is to be appreciated that various alterations, modifications, and improvements will readily occur to those skilled in the art.

Such alterations, modifications, and improvements are intended to be part of this disclosure, and are intended to be within the spirit and scope of disclosure. Further, though advantages of the technology described herein are indicated, not every embodiment of the technology described herein will include every described advantage. Some embodiments may not implement any features described as advantageous herein and in some instances one or more of the described features may be implemented to achieve further embodiments. Accordingly, the foregoing description and drawings are by way of example only.

The above-described embodiments can be implemented in any of numerous ways. For example, the embodiments may be implemented using hardware, software or a combination thereof. When implemented in software, the software code can be executed on any suitable processor or collection of processors, whether provided in a single computer or distributed among multiple computers. It should be understood that any component or collection of components that perform the functions described above can be generically considered as one or more controllers that control the above-discussed functions. The one or more controllers can be implemented in numerous ways, such as with dedicated hardware or with one or more processors programmed using microcode or software to perform the functions recited above.

In this respect, it should be understood that one implementation of the embodiments of the present invention comprises at least one non-transitory computer-readable storage medium (e.g., a computer memory, a portable memory, a compact disk, etc.) encoded with a computer program (e.g., a plurality of instructions), which, when executed on a processor, performs the above-discussed functions of the embodiments of the present invention. The computer-readable storage medium can be transportable such that the program stored thereon can be loaded onto any computer resource to implement the aspects of the present invention discussed herein. In addition, it should be understood that the reference to a computer program which, when executed, performs the above-discussed functions, is not limited to an application program running on a host computer. Rather, the term computer program is used herein in a generic sense to reference any type of computer code (e.g., software or microcode) that can be employed to program a processor to implement the above-discussed aspects of the present invention.

Various examples are methods that can be implemented either on a single computer or a combination of computer-based systems in a distributed network. Method examples are completed in various locations and by one or more systems. For example, and in accordance with the various aspects and embodiments of the invention, IP elements or units include processors (e.g., CPUs, GPUs, or NPUs), random-access memory (RAM—e.g., off-chip dynamic RAM or DRAM), a network interface for wired or wireless connections such as Ethernet, WIFI, 3G, 4G long-term evolution (LTE), 5G, 6G and other wireless interface standard radios. The system may also include various I/O interface devices, as needed for different peripheral devices such as touch screen sensors, geolocation receivers, microphones, speakers, Bluetooth peripherals, and USB devices, such as keyboards and mice, among others. By executing instructions stored in RAM devices, processors perform steps of methods as described herein.

Various aspects of the system described herein may be implemented in a cloud-based database environment, leveraging the scalability and flexibility of distributed computing resources. In this embodiment, the system's components—including the query interface, logical schema layer, storage constraints layer, and document generator—are deployed as microservices within a cloud infrastructure. These microservices communicate via APIs, allowing for independent scaling and updates of each component.

Some embodiments may involve or include one or more machine learning models. In some aspects, the systems and methods described herein may utilize one or more machine learning models to perform various functions and operations. These machine learning models may be implemented on one or more computer systems, which may include local computing devices, remote servers, cloud-based computing platforms, or distributed computing environments. The machine learning models may be trained using various techniques and may be configured to process input data and generate output predictions, classifications, or other results based on learned patterns and relationships.

In some cases, the one or more machine learning models may include supervised learning models, unsupervised learning models, semi-supervised learning models, or reinforcement learning models. The machine learning models may comprise neural networks, decision trees, support vector machines, random forests, gradient boosting machines, or other types of machine learning architectures. In some aspects, the neural networks may include deep learning models such as convolutional neural networks, recurrent neural networks, transformer models, or generative adversarial networks.

The one or more computer systems on which the machine learning models operate may include processors, memory, storage devices, and network interfaces configured to execute the machine learning models and process data. In some aspects, the computer systems may include specialized hardware such as graphics processing units (GPUS), tensor processing units (TPUs), or field-programmable gate arrays (FPGAs) to accelerate machine learning computations. The computer systems may be configured to receive input data from various sources, process the data using the machine learning models, and provide output results to users or other systems.

In some cases, the machine learning models may be trained using training data that includes labeled examples, unlabeled examples, or a combination thereof. The training process may involve adjusting parameters of the machine learning models to minimize a loss function or maximize a performance metric. Once trained, the machine learning models may be deployed on the one or more computer systems to perform inference operations on new input data. The machine learning models may be periodically retrained or updated based on new data or changing conditions to maintain or improve their performance over time.

In some aspects, the systems and methods described herein may involve various types of computer programmatic interfaces that facilitate interaction between users, systems, or components. These interfaces may include application programming interfaces (APIs), web services, software development kits (SDKs), or other programmatic interfaces that enable communication and data exchange between different software components or systems. The programmatic interfaces may be configured to receive requests, process data, and return responses in various formats such as JSON, XML, or other structured data formats. In some cases, the programmatic interfaces may support RESTful architectures, SOAP protocols, GraphQL queries, or other communication protocols to enable interoperability between different systems and platforms.

In some cases, the systems and methods may include graphical user interfaces (GUIs) that provide visual representations and interactive elements for users to interact with the system. The GUIs may include various interface elements such as buttons, menus, forms, sliders, checkboxes, radio buttons, dropdown lists, text fields, or other interactive components that allow users to input data, make selections, or trigger actions. The GUIs may be implemented using various technologies such as web-based interfaces, desktop applications, mobile applications, or other interface frameworks. In some aspects, the GUIs may be designed to be responsive and adaptive to different screen sizes, devices, or user preferences.

In some aspects, the systems and methods may support voice interfaces that enable users to interact with the system using spoken commands or natural language input. The voice interfaces may utilize speech recognition technologies to convert spoken words into text or commands that can be processed by the system. In some cases, the voice interfaces may also include text-to-speech capabilities to provide audible feedback or responses to users. The voice interfaces may be integrated with virtual assistants, smart speakers, mobile devices, or other voice-enabled platforms to provide hands-free interaction with the system.

In some cases, the systems and methods may include heads-up displays (HUDs) or augmented reality interfaces that overlay digital information onto the user's field of view. These interfaces may be implemented using wearable devices such as smart glasses, head-mounted displays, or other augmented reality hardware. The HUDs may present information, notifications, visualizations, or interactive elements in a manner that allows users to access information while maintaining awareness of their physical environment. In some aspects, the HUDs may be used in various applications such as navigation, training, maintenance, or other scenarios where hands-free access to information may be beneficial.

In some aspects, the systems and methods may support other types of interfaces including gesture-based interfaces, haptic interfaces, brain-computer interfaces, or multimodal interfaces that combine multiple input and output modalities. The gesture-based interfaces may utilize cameras, sensors, or other detection technologies to recognize hand movements, body gestures, or other physical actions as input commands. The haptic interfaces may provide tactile feedback through vibrations, force feedback, or other physical sensations to enhance user interaction. The multimodal interfaces may combine visual, auditory, tactile, or other sensory modalities to provide rich and intuitive user experiences. All of these interface types and variations thereof are within the scope of the invention and may be utilized individually or in combination to facilitate user interaction with the systems and methods described herein.

The terms “program” or “software” are used herein in a generic sense to refer to any type of computer code or set of processor-executable instructions that may be employed to program a computer or other processor to implement various aspects of the technology as described above. Additionally, one or more computer programs that when executed perform methods of the technology described herein need not reside on a single computer or processor, but may be distributed in a modular fashion amongst a number of different computers or processors to implement various aspects of the technology described herein.

Processor-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed.

Also, data structures may be stored in one or more non-transitory computer-readable storage media in any suitable form. For simplicity of illustration, data structures may be shown to have fields that are related through location in the data structure. Such relationships may likewise be achieved by assigning storage for the fields with locations in a non-transitory computer-readable medium that convey relationship between the fields. However, any suitable mechanism may be used to establish relationships among information in fields of a data structure, including through the use of pointers, tags or other mechanisms that establish relationships among data elements.

Various aspects of the present invention may be used alone, in combination, or in a variety of arrangements not specifically discussed in the embodiments described in the foregoing and are therefore not limited in their application to the details and arrangement of components set forth in the foregoing description or illustrated in the drawings. For example, aspects described in one embodiment may be combined in any manner with aspects described in other embodiments.

Also, the technology described herein may be embodied as a method, of which examples are provided herein including with reference to FIGS. 4, 5, 8, 11, 13, and 14. The acts performed as part of any of the methods may be ordered in any suitable way. Accordingly, embodiments may be constructed in which acts are performed in an order different than illustrated, which may include performing some acts simultaneously, even though shown as sequential acts in illustrative embodiments.

The indefinite articles “a” and “an,” as used herein in the specification and in the claims, unless clearly indicated to the contrary, should be understood to mean “at least one.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, for example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B,” when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term). The phraseology and terminology used herein is for the purpose of description and should not be regarded as limiting. The use of “including,” “comprising,” “having,” “containing,” “involving,” and variations thereof, is meant to encompass the items listed thereafter and additional items.

Unless otherwise specified, the terms “approximately,” “substantially,” and “about” may be used to mean within +10% of a target value in some embodiments. The terms “approximately,” “substantially” and “about” may include the target value.

Having described several embodiments of the techniques described herein in detail, various modifications, and improvements will readily occur to those skilled in the art. Such modifications and improvements are intended to be within the spirit and scope of the disclosure. Accordingly, the foregoing description is by way of example only, and is not intended as limiting. The techniques are limited only as defined by the following claims and the equivalents thereto.

1. A robotic system comprising:
a plurality of mechanical joints configured between components of the robotic system such that the components are movably connected;
a plurality of actuators configured to control positions of the plurality of mechanical joints;
a plurality of sensors configured to detect operating conditions of respective actuators of the plurality of actuators;
a processor configured to control power to the plurality of actuators and to process signals received from the plurality of sensors; and
a non-transitory computer-readable storage medium storing processor executable instructions that when executed by the at least one computer hardware processor enforce safe operating limits of the robotic system, wherein the processor executable instructions cause the processor to:
receive sensor data from the plurality of sensors;
generate control signals for controlling the plurality of actuators;
determine whether the control signals exceed safe operating limits; and
upon determining the control signals exceed the safe operating limits, generate an intervention signal.

2. The robotic system of claim 1, wherein the plurality of actuators is configured in a plurality of kinematic chains, wherein each kinematic chain includes a respective common electrical bus electrically coupled to each actuator of the plurality of actuators.

3. The robotic system of claim 1, wherein determining the control signals exceed the safe operating limits comprises:
receiving the control signals and sensor data from the plurality of sensors;
estimating operational parameters for the plurality of actuators based on the received control signals; and
determining that the control signals exceed the safe operating limits when the operating conditions deviate from the estimate operational parameters by a threshold tolerance.

4. The robotic system of claim 3, further comprising:
identifying an alternative pose that involves a different position than a target pose;
initializing a transition to the alternative pose based on the intervention signal; and
after executing the transition to the alternative pose, initializing a transition back to the target pose.

5. The robotic system of claim 4, wherein initializing a transition to the alternative pose comprises selecting an alternative policy.

6. The robotic system of claim 4, wherein initializing a transition to the alternative pose comprises providing an alternative command to an active policy.

7. The robotic system of claim 1, wherein determining the control signals exceed the safe operating limits comprises:
determining whether the operating conditions exceed the safe operating limits; and
upon determining that the operating conditions exceed the safe operating limits, modifying the control signals to limit the operating conditions to the safe operating limits based on the intervention signal.

8. The robotic system of claim 7, further comprising alerting a user that the operating conditions exceeded the safe operating limits and that the control signals are being limited.

9. The robotic system of claim 8, wherein alerting the user that the operating conditions exceeded the safe operating limits include activating a plurality of LEDs of the robotic system.

10. The robotic system of claim 8, wherein alerting the user that the operating conditions exceeded the safe operating limits include alerting a remote user with an error tone.

11. The robotic system of claim 7, wherein modifying the control signals to limit the operating conditions to the safe operating limits comprises generating an override signal for an active task.

12. The robotic system of claim 11, wherein the override signal stops execution of the active task and instructs the robotic system to place and release a carried object to decrease a load from the carried object on the robotic system.

13. The robotic system of claim 11, wherein the override signal instructs the robotic system to redistribute a load of a carried object from a first subset of the plurality of actuators to a second subset of the plurality of actuators.

14. The robotic system of claim 11, wherein the override signal instructs the robotic system to redistribute a load of a carried object by bracing the carried object against a housing of the robotic system.

15. The robotic system of claim 11, further comprising a visio-temporal model to analyze output from a vision subsystem of the robotic system, wherein the visio-temporal model classifies objects in an environment of the robotic system as load-bearing or non-compatible relative to a weight of the robotic system.

16. The robotic system of claim 15, wherein the override signal instructs the robotic system to brace the robotic system against a load-bearing object.

17. The robotic system of claim 15, wherein the override signal instructs the robotic system to use a load-bearing object as a counterbalance.

18. The robotic system of claim 1, wherein determining the control signals exceed the safe operating conditions comprises:
comparing the operating conditions to the safe operating limits to determine whether the operating conditions exceed the safe operating limits; and
upon determining that the operating conditions exceed the safe operating limits, initializing a transition from an active first policy to an alternative policy.

19. The robotic system of claim 18, further comprising initializing a transition to the first policy when operational parameters of the first policy can be executed within the safe operating limits.

20. The robotic system of claim 19, wherein the safe operating limits comprise a maximum operating temperature of each actuator in the plurality of actuators.

21. The robotic system of claim 20, wherein the comparing the operating conditions to the safe operating limits to determine whether the operating conditions exceed the safe operating limits comprises comparing a thermal heating associated with the control signals and corresponding actuators with a heat capacitance of the corresponding actuators and when the thermal heating would exceed the maximum operating temperature, initializing a transition to the alternative policy.

22. The robotic system of claim 19, wherein the safe operating limits comprise a maximum operating current of the plurality of actuators and a battery status.

23. The robotic system of claim 22, wherein the safe operating limits include a maximum operating current of the plurality of actuators associated with a normal battery status and a reduced operating current of the plurality of actuators associated with a low battery status.

24. The robotic system of claim 1, further comprising a safety override policy that, when active, will override intervention signals and authorize control signals that exceed the safe operating limits of the robotic system.

25. The robotic system of claim 24, wherein a user authorizes the safety override policy.

26. The robotic system of claim 24, wherein the safety override policy is authorized by the robotic system to avoid collision between the robotic system and a user.

27. The robotic system of claim 26, wherein the safety override policy is authorized by the robotic system to avoid collision between the robotic system and a household animal.

28. A method of executing motor control of a robotic system, the method comprising using a computer processor to:
receive commands based on a target pose;
receive component data for the robotic system;
estimate operating conditions for the robotic system; and
process the estimated operating conditions and the commands using a trained machine learning model to generate control signals that comply with safe operating limits.

29. The method of claim 28, wherein estimating the operating conditions for the robotic system comprises estimating the current of a plurality of actuators.

30. The method of claim 29, wherein estimating the current of the plurality of actuators comprises estimating a current draw for respective actuators of the plurality of actuators based on an angular velocity, applied torque, resistance, torque constant, and efficiency of the respective actuator.

31. The method of claim 30 further comprising calculating a total current estimate for a subset of the plurality of actuators that share a common electrical bus.

32. The method of claim 28, wherein estimating the operating conditions for the robotic system comprises estimating the temperature of a plurality of actuators.

33. The method of claim 32, wherein estimating the temperature of the plurality of actuators comprises estimating a change in temperature of the respective actuators of the plurality of actuators based on a heating coefficient and a cooling coefficient for the respective actuator.

34. The method of claim 33, wherein the heating coefficient and the cooling coefficient for a respective actuator are estimated by:
applying a test torque to a stalled actuator;
collecting torque and temperature readings over a plurality of test torque applications; and
estimating the heating coefficient and the cooling coefficient from change in the torque and temperature readings in response to the test torque applications.

35. A robotic system comprising:
a computer processor configured to control power to a plurality of actuators and to process signals received from a plurality of sensors; and
a non-transitory computer-readable storage medium storing processor executable instructions that when executed by the computer processor cause the computer processor to:
receive commands based on a target pose;
receive component data for the robotic system;
estimate operating conditions for the robotic system; and
process the estimated operating conditions and the commands using a trained machine learning model to generate control signals that comply with safe operating limits.
